(19) United States
(12) Patent Application Publication
(10) Pub. No.: US 2008/0237906 A1
(43) Pub. Date: Oct. 2, 2008

(54) METHOD OF MANUFACTURING PELLET AGGREGATE

(75) Inventor: Tetsuya Yoshida, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/058,143

(22) Filed: Mar. 28, 2008

(30) Foreign Application Priority Data
Mar. 28, 2007 (JP) 2007-085832

(51) Int. Cl. B29B 9/10

(52) U.S. Cl. 264/5

(57) ABSTRACT

A method for manufacturing a pellet aggregate by melting a raw material including a saturated norbornene resin and an additive to prepare a fluid, and cutting the fluid into pellets. In the method, the cutting of the fluid into the pellets is performed in a liquid to separate powder generated in manufacturing the pellets together with the liquid. And/Or, the manufactured pellets are passed through a sieve having a mesh size of 1 mm or more and 2 mm or less to separate powder generated in manufacturing the pellets. Whereby, the content of the powder in the pellet aggregate becomes a predetermined amount or less.

### BACKGROUND OF THE INVENTION

1. Field of the Invention

The present invention relates to a method of manufacturing a pellet aggregate, and more particularly, to a method of manufacturing a pellet aggregate preferably used as a raw material for a melt film formation method.

2. Description of the Related Art

A saturated norbornene resin film is formed by melting numerous pellets (hereinafter referred to as a “pellet aggregate”) containing a saturated norbornene resin in an extruder and extruding into a die, ejecting the molten saturated norbornene resin from a discharge port of the die in a sheet form, and cooling to solidify the sheet. (This is called a melt film formation method). Thereafter, the obtained sheet is stretched at least either one of the longitudinal direction (machine direction: MD) and the lateral direction (transverse direction: TD) to obtain a film having a desired in-plane retardation (Re) and thickness retardation (Rth, also referred to as “thickness-direction retardation”). This film is used as an optical compensation film (also referred to as a “phase difference film”) of a liquid crystal display device for enlarging a viewing angle (see, for example, Japanese National Publication of International Patent Application No. 6-501040).

A pellet aggregate mentioned above is formed by melting a saturated norbornene resin and various types of additives such as a plasticizer to prepare a melt, extruding the melt by an extruder in a thick and linear fluid (hereinafter referred to as a “strand”), cutting the strand into pieces (pellets) by a cutter, and housing these pellets in a container. The pellet aggregate obtained by the method above contains powder, which is debris primarily produced in cutting a strand into pieces.

When a saturated norbornene resin is formed into a film by the melt film formation method, it is necessary to dry the resin before loading the resin to an extruder. In the drying step, the additives contained in the resin vaporized. Especially from powder having a large specific surface area, the additives, mainly a plasticizer vaporize. Because of the vaporization phenomenon, pellets and powder contain components in different ratios. When a film is formed using a pellet aggregate which is a mixture of pellets and powder in accordance with the melt film formation method, the powder tends to be gelatinized (solidified). The powder once gelatinized results in a foreign substance in the film. The presence of such a foreign substance causes a problem and affects optical characteristics of a film.

### SUMMARY OF THE INVENTION

An object of the present invention is to provide a pellet aggregate serving as a raw material for forming a film containing no foreign matters.

In order to attain the aforementioned object, according to a first aspect of the present invention, a method of manufacturing a pellet aggregate by melting a raw material including a saturated norbornene resin and an additive to prepare a fluid, and cutting the fluid into pellets, the method comprises performing the cutting of the fluid into the pellets in a liquid to separate powder generated in manufacturing the pellets together with the liquid, and the content of the powder in the pellet aggregate thereby becomes a predetermined amount or less. According to the first aspect, since the fluid (strand) is cut into pellets while the liquid is supplied, the powder generated in cutting can be removed from the pellets. Therefore, the content of powder in the pellet aggregate becomes a predetermined value or less (preferably, 0.1% by mass or less). The pellet aggregate can be preferably used as a raw material for forming a film by a melt-film forming method. In the present invention, the term “melting” is used to refer mixing and kneading while heating.

According to a second aspect of the present invention, the method according to the first aspect of the present invention further comprises passing the manufactured pellets through a sieve having a mesh size of 1 mm or more and 2 mm or less to separate the powder contained in the pellet aggregate. According to the second aspect, since a strand (fluid) is cut into pellets while supplying a liquid, the powder generated in cutting can be removed from the pellets. Furthermore, since powder is removed by a sieve, the content of the powder in a pellet aggregate becomes a predetermined value or less (preferably, 0.1% by mass or less). As mentioned above, in the aspects of the present invention, powder can be removed from a pellet aggregate without providing a specific unit to a pellet manufacturing line. The pellet aggregate is extremely preferably used as a raw material for forming a film by a melt-film forming method. According to a third aspect of the present invention, in the method according to the first aspect or the second aspect of the invention, it is preferable that the liquid is water. According to a fourth aspect of the present invention, in the method according to the third aspect of the present invention, it is preferable that the temperature of water is set at 35° C. or more and 90° C. or less.

According to a fifth aspect of the invention, for attaining the aforementioned object, a method of manufacturing a pellet aggregate by melting a raw material including a saturated norbornene resin and an additive to form a fluid, and cutting the fluid into pellets, the method comprises passing the manufactured pellets through a sieve having a mesh size of 1 mm or more and 2 mm or less to separate powder generated in manufacturing pellets, and the content of the powder in the pellet aggregate thereby becomes a predetermined amount or less. According to the fifth aspect, after the strand (fluid) is formed into the pellets, powder is removed by the sieve. Therefore, the content of the power in the pellet aggregate becomes a predetermined amount or less (preferably 0.1% by mass or less). The pellet aggregate can be preferably used as a raw material for forming a film by a melt-film forming method.

According to a sixth aspect of the present invention, in the method according to any one of the first to fifth aspects of the present invention, it is preferable that the fluid is cut by use of a blade, which is arranged so as to have a cutting angle θ(°) within the range of 30° or more and 75° or less when a forward direction of the fluid is taken as 0°. According to a seventh aspect of the present invention, in the method according to any one of the first to sixth aspects of the present invention, it is preferable that the powder has an average particle size of 1 mm or less measured by a sieving method. According to an eighth aspect of the present invention, in the method according to any one of the first to seventh aspects of the present invention, it is preferable that the content of the powder is 0.1% by mass or less. According to a ninth aspect of the present invention, in the method according to any one of the first to eighth aspects of the present invention, it is preferable that the additive comprises at least one plasticizer. According to a tenth aspect of the present invention, in the method according to any one of the first to ninth aspects of the present invention, it is preferable that the pellet aggregate is a raw material for a saturated norbornene resin film.

According to the present invention, it is possible to obtain a pellet aggregate serving as a raw material for forming a film containing no foreign matter.

### BRIEF DESCRIPTION OF THE DRAWINGS

FIG. 1 is a schematic diagram showing an embodiment of a manufacturing line used in a method for manufacturing a pellet aggregate according to the present invention;

FIG. 2 is a schematic diagram showing a substantial part of the manufacturing line of FIG. 1;

FIG. 3 is a schematic diagram showing another embodiment of a manufacturing line used in a method for manufacturing a pellet aggregate according to the present invention;

FIG. 4 is a schematic diagram showing still another embodiment of a manufacturing line used in a method for manufacturing a pellet aggregate according to the present invention; and

FIG. 5 is a schematic diagram showing an embodiment of a manufacturing line for manufacturing a film using a pellet aggregate according to the present invention.

### DETAILED DESCRIPTION OF THE PREFERRED EMBODIMENTS

Preferred embodiments for a method of manufacturing a pellet aggregate according to the present invention will be explained.

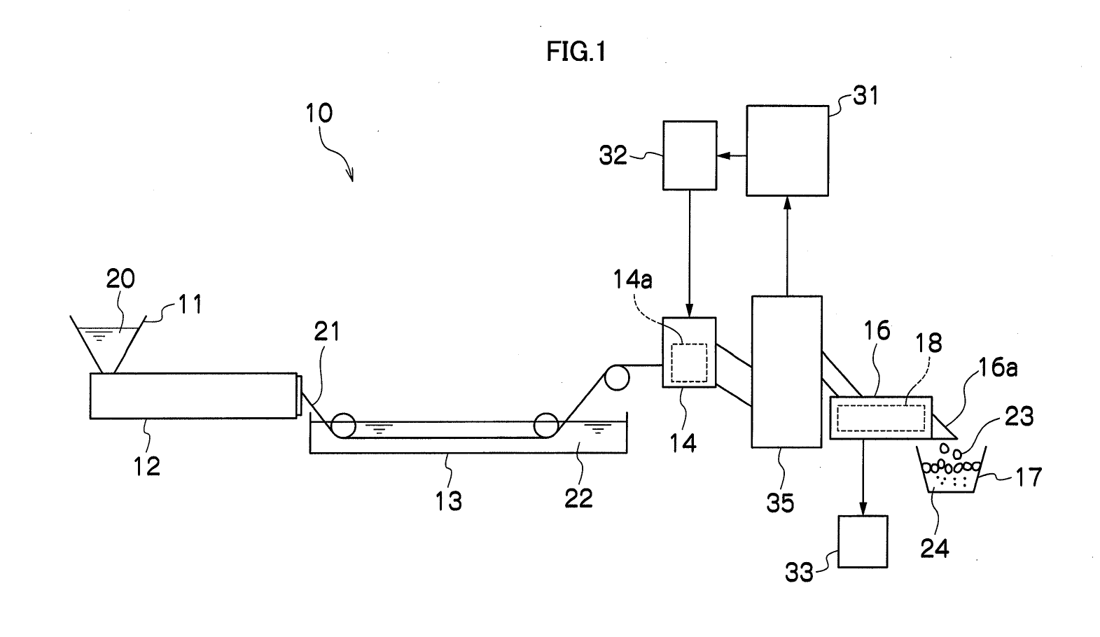

FIG. 1 shows a schematic view showing an embodiment of a manufacturing line 10 for manufacturing a pellet aggregate. The manufacturing line 10 is constituted of a hopper 11, an extruder 12, a water vessel 13, a cutting unit 14, a pellet/water separation unit 35, a sieving unit 16, and a container 17.

The hopper 11 is charged with a pellet raw-material 20 composed of a saturated norbornene resin serving as a main component of pellets and additives. As additives, a plasticizer and a UV absorber may be mentioned. Examples of the plasticizer include, but not limited to, phosphate esters (phosphoric esters), alkyl phthalyl alkyl glycolates, carboxylic esters and fatty acid esters of polyhydric alcohols. Provided that the amount of the saturated norbornene resin is regarded as 100% by weight, the additives are preferably used in a concentration that is 1 to 5 fold as large as a predetermined concentration in the resultant film.

The pellet raw-material 20 is introduced into the extruder 12 from the hopper 11. In the extruder 12, the pellet raw-material 20 is sufficiently kneaded while being heated into a mixture of a saturated norbornene resin and the additives. This mixture is extruded from the extruder 12 as a fluid (hereinafter referred to as a “strand 21”). The strand 21 is fed to a water vessel 13 containing water 22. The water 22 in the water vessel 13 is preferably set at from 35° C. or more and 90° C. or less, more preferably, 55° C. or more and 80° C. or less, and most preferably, 65° C. or more and 75° C. or less. When the temperature of water 22 is less than 35° C., the temperature of the strand 21 is too low. As a result, when the strand 21 is cut, it is easily cracked, generating a large amount of powder. In contrast, when the temperature exceeds 90° C., the amount of water vaporized from the water vessel increases. This is unfavorable in view of stable operation.

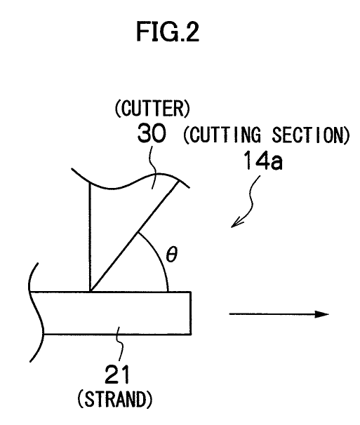

The strand 21 acquiring a desired hardness is fed to the cutting unit 14. The cutting unit 14 has a cutting section 14a equipped with a cutter 30 (see FIG. 2). To supply water (washing water) to the cutting section 14a, a water supply unit 31 is connected to the cutting unit 14 by way of a powder separation unit 32. The powder separation unit 32 is provided in order to separate the washing water from debris generated when a strand is cut. Since water is supplied to the cutting section 14a, powder generated when the strand 21 is cut can be collected together with water. The temperature of water to be supplied to the cutting section 14a is preferably 35° C. or more and 80° C. or less, more preferably, 55° C. or more and 75° C. or less, and most preferably, 65° C. or more and 75° C. or less.

As shown in FIG. 2, the cutter 30 is arranged in such a manner that the cutting edge forms a desired angle with respect to the forward direction of the strand 21. The cutting angle θ° preferably falls within the range of 30° or more and 75° or less, more preferably, 40° or more and 70° or less, and most preferably, 45° or more and 65° or less. Preferable examples of the material for the cutter 30 include, but not particularly limited to, an alloy tool steel, high-speed tool steel, and super hard alloy.

Numerous pellets can be continuously obtained by cutting the strand in the cutting unit 14. In the pellet/water separation unit 35, water attached to the pellets is separated. The pellets are then fed to the sieving unit 16, in which remaining powder attached to pellets not collected by water is removed from the pellets. A sieve 18 is provided in the sieving unit 16 to remove powder. The mesh size of the sieve 18 is preferably from 1 mm or more and 2 mm or less, more preferably, 1.2 mm or more and 1.8 mm or less, and most preferably, 1.4 mm or more and 1.6 mm or less. The sieving unit 16 has a debris collection unit 33 equipped thereto. In the embodiment of the present invention, the mesh size of the sieve 18 is defined as follows. When the opening of the mesh is approximated to a rectangle, the longer one of the perpendicular and vertical sides is defined as a mesh size. When the mesh is approximated to a circle, the diameter thereof is defined as a mesh size. The powder separated by the sieving unit 16 is collected by a debris collection unit 33.

Finally, pellets 23 are continuously fed from a discharge port 16a of the sieving unit 16 to a container 17 to be a pellet aggregate 24 in the container 17. The amount of powder contaminated in the pellet aggregate 24 is 0.1% by weight or less, 0.08% by weight or less under more preferable conditions, and 0.05% by weight or less under the most preferable conditions. In the embodiment of the present invention, particles mixed in the pellet aggregate 24 and having an average particle size of 1 mm or less are regarded as powder. Note that values measured by a sieving method are used to obtain an average particle size in the embodiment of the present invention. Since powder is smaller than pellets, an additive, in particular, a plasticizer, tends to vaporize from the powder. As a result, the powder may be likely dominantly composed of a saturated norbornene resin. When a pellet aggregate containing such powder is subjected to film formation in accordance with a melt film formation method, the main component of the powder, saturated norbornene resin, is gelatinized to form a solid. The solid is present as a foreign substance in the film. However, when a pellet aggregate according to the embodiment of the present invention having a content of powder within a predetermined value or less (for example, 0.1 wt % or less) is subjected to film formation, the amount of foreign substance in the film can be reduced.

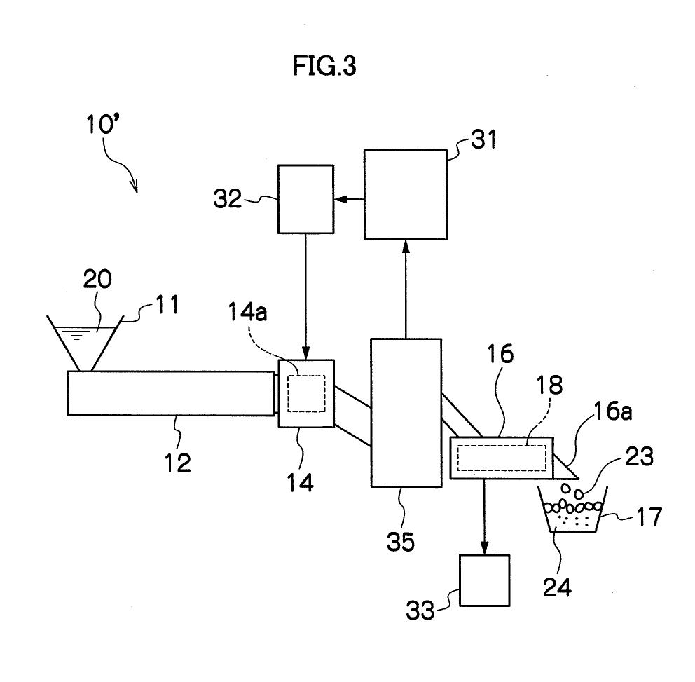

FIG. 3 shows another embodiment of the manufacturing line 10′ for a pellet aggregate according to the present invention. In FIG. 3, the strand 21 is fed from the extruder 12 into the cutting unit 14. The cutting section 14a of the cutting unit 14 has the cutter shown in FIG. 2 and the water supply unit 31 for supplying water (washing water) to the cutting section 14a is connected to the cutting unit 14 by way of the powder separation unit 32. The strand is cut into pellets by cutting in the same manner as in the previous embodiment. Thereafter, water is separated from the pellets by the pellet/water separation unit 35. The pellets are fed to the sieving unit 16 to remove powder not collected with water. To remove powder, a sieve 18 is provided in the sieving unit 16. The pellets 23 are continuously fed from the discharge port 16a to the container 17. Numerous pellets 23 are stored in the container 17 to be a pellet aggregate 24. The amount of powder contained in the pellet aggregate 24 obtained herein is also 0.1 wt % or less. Therefore, when the pellet aggregate 24 is subjected to film formation in accordance with a melt film formation method, a film whose contamination with foreign substance is suppressed can be obtained.

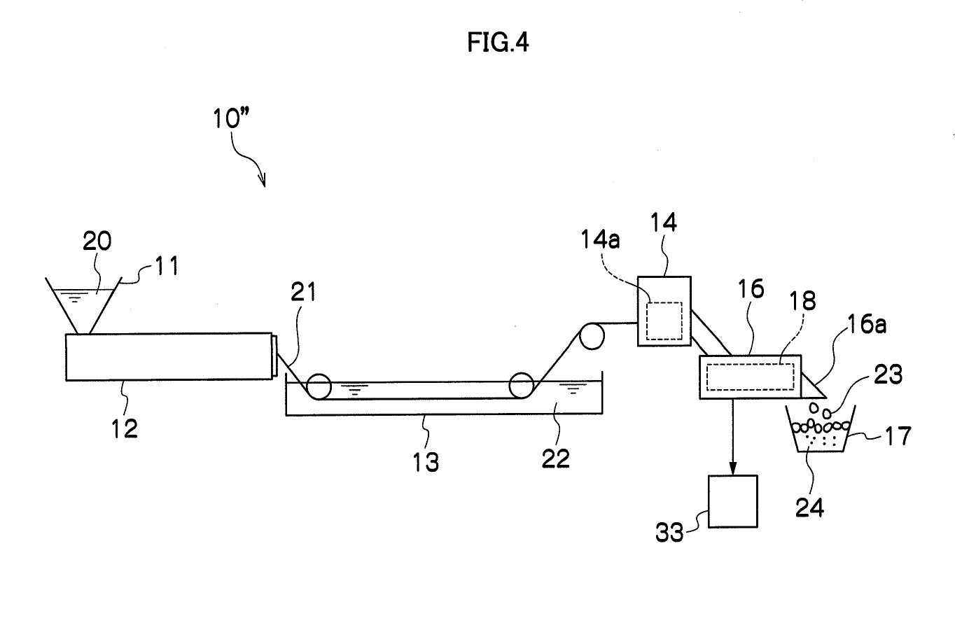

FIG. 4 shows another embodiment of the manufacturing line 10″ of a pellet aggregate according to the present invention. In FIG. 4, the strand 21 fed from the water vessel 13 is fed into the cutting unit 14. The strand 21 is cut into pellets by cutting at the cutting section 14a of the cutting unit 14. Subsequently, the pellets are fed to the sieving unit 16. The sieving unit 16 has the sieve 18 mentioned above and a debris collection unit 33. After the strand 21 is cut into pellets 23 in the same manner as in the previous embodiments, the pellets are continuously fed from the discharge port 16a to the container 17. Numerous pellets 23 are housed in the container 17 to form a pellet aggregate 24. The pellet aggregate 24 obtained herein contains powder also in an amount of 0.1 wt % or less. Therefore, when the pellet aggregate 24 is subjected to film formation in accordance with a melt film formation method, a film whose contamination with foreign substance is suppressed can be obtained.

A method for manufacturing a film using a pellet aggregate according to the present invention will be explained.

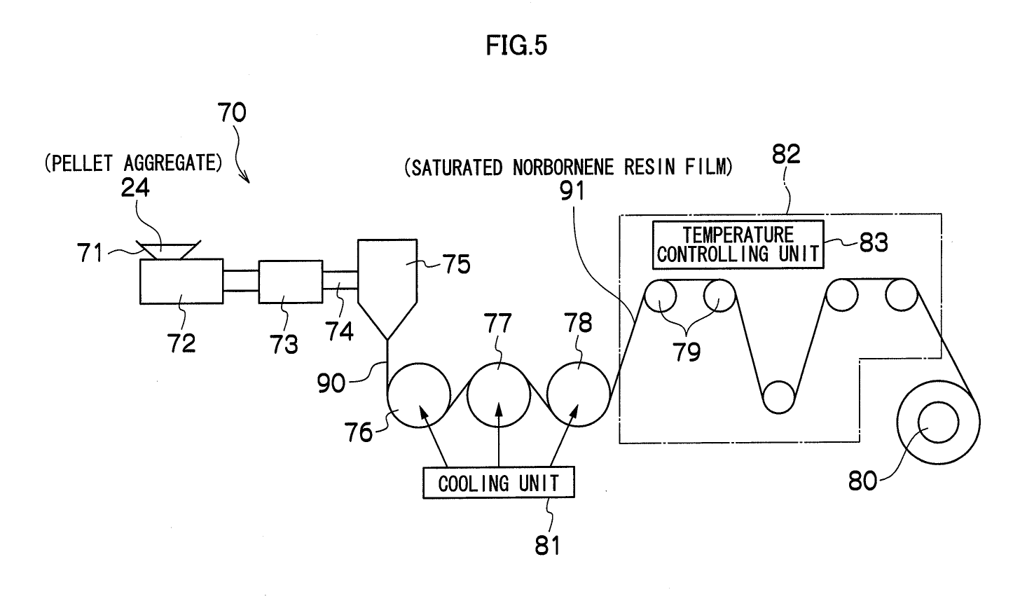

FIG. 5 shows a schematic structure of a manufacturing line 70 for a saturated norbornene resin film. The manufacturing line 70 is constituted of a hopper 71, an extruder 72, a gear pump 73, a pipe 74, a die 75, a casting drum 76, cooling drums 77, 78, a roller 79 and a winder 80.

The pellet aggregate 24 containing a saturated norbornene resin as a main component (hereinafter simply referred to as “pellet aggregate”) is stored in the hopper 71. The pellet aggregate 24 is fed from the hopper 71 to the extruder 72 and melted therein to a fluid (hereinafter referred to as “molten saturated norbornene resin”). The temperature of the molten saturated norbornene resin extruded from the extruder 72 is preferably from 190° C. or more and 240° C. or less, more preferably, 195° C. or more and 235° C. or less, and most preferably, 200° C. or more and 230° C. or less. When the extruding temperature is less than 190° C., the crystal of a saturated norbornene resin is not melted sufficiently, with the result that fine crystals are likely to remain in the resultant saturated norbornene resin film. Even if such a saturated norbornene film is stretched, desirable drawing cannot be performed. In some cases, orientational ordering of saturated norbornene molecules is not sufficiently controlled and thus desired retardation values (Re and Rth) cannot be obtained. In other cases, film-breakage takes place. In contrast, when the extrusion temperature exceeds 240° C., thermolysis takes place and a saturated norbornene resin may degrade. The film obtained from such a degraded saturated norbornene resin may have a reduced yellow index (YI value).

The molten saturated norbornene resin is fed by the gear pump 73 and passes through the pipe 74 and enters into the die 75. The molten saturated norbornene resin is ejected from the die 75 in sheet form (hereinafter referred to as a “saturated norbornene resin sheet”) 90 and cast on the casting drum 76. At the downstream side of the casting drum 76, cooling drums 77, 78 are arranged.

FIG. 5 shows an example in which two cooling drums are arranged; however, the number of cooling drums is not limited to two in the present invention. It is preferable that each of the drums 76 to 78 is connected to a cooling unit 81 to independently control the temperature thereof. The saturated norbornene resin sheet 90 is cooled on the surface of each of the drums. Hereinafter, the saturated norbornene resin sheet 90 thus cooled will be referred to as a “saturated norbornene resin film 91”.

The saturated norbornene resin film 91 is sent to a cooling zone 82 while being wound up on the roller 79 and further cooled. The cooling zone 82 may be further divided into a plurality of districts, the temperature of which may be separately controlled. The saturated norbornene resin film 91 thus cooled is rolled up into a roll by the winder 80.

Saturated norbornene resins, processing methods of a saturated norbornene resin film, and the like suitable for the embodiment of the present invention will be then described in detail along the procedures.

### (Saturated Norbornene Resins)

Examples of saturated norbornene resins used in the present invention include: (1) resins obtained by subjecting a polymer resulting from ring opening (co)polymerization of a norbornene monomer to polymer modification, such as addition of maleic acid or addition of cyclopentadiene, depending on the situation, and then hydrogenating the modified polymer; (2) resins obtained by subjecting a norbornene monomer to addition polymerization; (3) resins obtained by subjecting a norbornene monomer and an olefin monomer, such as ethylene or α-olefin, to addition copolymerization. Polymerization and hydrogenation can be performed by a conventional method.

Examples of norbornene monomers include: norbornene, alkyl and/or alkylidene-substituted derivatives thereof, such as 5-methyl-2-norbornene, 5-dimethyl-2-norbornene, 5-ethyl-2-norbornene, 5-butyl-2-norbornene, 5-ethylidene-2-norbornene; derivatives thereof substituted with a polar group such as halogen; dicyclopentadiene and 2,3-hydrodicyclopentadiene; dimethanooctahydronaphthalene, alkyl and/or alkylidene-substituted derivatives thereof and derivatives thereof substituted with a polar group such as halogen, for example, 6-methyl-1,4:5,8-dimethano-1,4,4a,5,6,7,8,8a-octahydronaphthalene, 6-ethyl-1,4:5,8-dimethano-1,4,4a,5,6,7,8,8a-octahydronaphthalene, 6-ethylidene-1,4:5,8-dimethano-1,4,4a,5,6,7,8,8a-octahydronaphthalene, 6-chloro-1,4:5,8-dimethano-1,4,4a,5,6,7,8,8a-octahydronaphthalene, 6-cyano-1,4:5,8-dimethano-1,4,4a,5,6,7,8,8a-octahydronaphthalene, 6-pyridyl-1,4:5,8-dimethano-1,4,4a,5,6,7,8,8a-octahydronaphthalene, and 6-methoxycarbonyl-1,4:5,8-dimethano-1,4,4a,5,6,7,8,8a-octahydronaphthalene; addition products of cyclopentadiene and tetrahydroindene; and trimers or tetramers of cyclopentadiene, such as 4,9:5,8-dimethano-3a,4,4a,5,8,8a,9,9a-octahydro-1H-benzoindene, 4,11:5, 10:6,9-trimethano-3a,4,4a,5,5a,6,9,9a,10,10a,11,11a-dodecahydro-1H-cyclopentaanthracene.

In the embodiment of the present invention, other cycloolefins polymerizable by ring opening polymerization may be used together within the limit in which the object of the present invention is not damaged. Specific examples of such cycloolefins include compounds having a reactive double bond, such as cyclopentene, cyclooctene and 5,6-dihydrodicyclopentadiene.

The saturated norbornene resin used in the present invention has a number average molecular weight of usually 25,000 to 100,000, preferably 30,000 to 80,000, more preferably 35,000 to 70,000 as measured by gel permeation chromatography (GPC) using a toluene solvent. When the number average molecular weight is too small, the resin has a poor mechanical strength, and when it is too large, operationability in molding becomes poor.

In the embodiment of the present invention, the saturated norbornene resin has a glass transition temperature (Tg) of preferably 100° C. or more and 250° C. or less, more preferably 115° C. or more and 220° C. or less, further preferably 130° C. or more and 200° C. or less.

Where desired, additives such as a phenol or phosphorus antioxidant, an antistatic agent or an ultraviolet absorber may be added to the thermoplastic saturated norbornene resin used in the embodiment of the present invention. In particular, since liquid crystal is usually degraded by ultraviolet light, an ultraviolet absorber is preferably added in the case where no other protective measures such as laminating a UV protection filter is taken. As such ultraviolet absorber, benzophenone ultraviolet absorbers, benzotriazole ultraviolet absorbers and acrylonitrile ultraviolet absorbers may be used, and of these, benzophenone ultraviolet absorbers are preferred, which are to be added in an amount of usually 10 to 100,000 ppm, preferably 100 to 10,000 ppm. Further, when preparing a sheet by solvent casting, a leveling agent is preferably added in order to reduce surface roughness. As such leveling agent, for example, fluorine nonionic surfactants and leveling agents for coating such as a special acrylic resin leveling agent and a silicone leveling agent may be used. Of these, those highly compatible with a solvent is preferred, and the amount to be added of the leveling agent is usually 5 to 50,000 ppm, preferably 10 to 20,000 ppm.

### (Melt Film Formation)

### (i) Melting

Before used for melt film formation, the saturated norbornene resin is preferably pelletized. Pelletizing the saturated norbornene resin makes it possible to suppress the surging in the hopper of a melt extruder, thereby ensuring stable feeding of the resin. The pellet cross-sectional area and the pellet length are 1 mm² or more and 300 mm² or less and 1 mm or more and 30 mm or less, respectively, and more preferably 2 mm² or more and 100 mm² or less and 1.5 mm or more and 10 mm or less, respectively.

The pellets of the saturated norbornene resin are fed into a melt extruder, dehydrated at a temperature of 100° C. or more and 200° C. or less for 1 minute or more and 10 hours or less, and kneaded and extruded. The kneading can be performed using a uniaxial or biaxial extruder.

The saturated norbornene resin having been kneaded is fed into a cylinder through the feed opening of the extruder. The cylinder is made up of: a feeding section where the saturated norbornene resin fed through the feed opening is transported in a fixed amount (area A); a compressing section where the saturated norbornene resin is melt kneaded and compressed (area B); and a measuring section where measurement is made (area C), from the feed opening side in this order. To prevent the molten resin from being oxidized by oxygen remaining in an extruder, it is preferable to carry out the above described operations in the stream of an inert gas (e.g. nitrogen) or while performing vacuum evacuation using an extruder equipped with a vent. The screw compression ratio of the extruder is set to 2.5 to 4.5 and L/D is set to 20 to 70. The “screw compression ratio” herein used means the volume ratio of the feeding section A and the measuring section C, in other words, the value obtained by dividing the volume of the feeding section A per unit length by the volume of the measuring section C per unit length, which is calculated using the outside diameter d1 of the screw shaft of the feeding section A, the outside diameter d2 of the screw shaft of the measuring section C, the diameter a1 of the groove portion of the feeding section A, and the diameter a2 of the groove portion of the measuring section C. The “L/D” herein used means the ratio of the length of the cylinder to the inside diameter of the cylinder. The extrusion temperature is set to 240° C. to 320° C., preferably to 250° C. to 310° C., and more preferably to 260° C. to 300° C.

As an extruder, generally a uniaxial extruder, which requires comparatively lower equipment costs, is often used. Types of uniaxial extruder include: for example, fullflight-type, Madock-type and Dulmage-type. For the saturated norbornene resin, fullflight-type screw extruder is preferably used. A biaxial extruder which is provided with a vent midway along its length, and therefore, makes it possible to perform extrusion while removing unnecessary volatile components can also be used by changing the screw segment, though it requires high equipment costs. Types of biaxial extruder include: broadly, co-rotating type and counter-rotating type, and either of the types can be used. However, preferably used is a co-rotating type of biaxial extruder which causes less residence of the resin and has a high self-cleaning performance. A biaxial extruder is suitable for the film formation of saturated norbornene resin, because it makes possible extrusion at low temperatures due to its high kneading performance and high resin-feeding performance, though its equipment costs are high. In a biaxial extruder, if a vent opening is properly arranged, pellets or powder of saturated norbornene resin can be used in the undried state or the selvedges of the film produced in the course of the film formation can also be reused in the undried state.

The preferable diameter of the screw varies depending on the intended amount to be extruded per unit time; however, it is preferably 10 mm or more and 300 mm or less, more preferably 20 mm or more and 250 mm or less, and much more preferably 30 mm or more and 150 mm or less.

### (ii) Filtration

To filter foreign matters in the resin or avoid the damage to the gear pump caused by such foreign matters, it is preferable to perform a so-called breaker-plate-type filtration which uses a filter medium provided at the extruder outlet. To filter foreign matters with much higher precision, it is preferable to provide, after passing the gear pump, a filter in which a so-called leaf-type disc filter is incorporated. Filtration can be performed with a single filtering section, or it can be multi-step filtration with a plurality of filtering sections. A filter medium with higher precision is preferably used; however, taking into consideration the pressure resistance of the filter medium or the increase in filtration pressure due to the clogging of the filter medium, the filtration precision is preferably 15 μm to 3 μm and more preferably 10 μm to 3 μm. A filter medium with higher precision is particularly preferably used when a leaf-type disc filter is used to perform final filtration of foreign matters. And in order to ensure suitability of the filter medium used, the filtration precision may be adjusted by the number of filter media loaded, taking into account the pressure resistance and filter life. From the viewpoint of being used at high temperature and high pressure, the type of the filter medium used is preferably a steel material. Of the steel materials, stainless steel or steel is particularly preferably used. From the viewpoint of corrosion, particularly desirably stainless steel is used. A filter medium constructed by weaving wires or a sintered filter medium constructed by sintering, for example, metal long fibers or metal powder can be used. However, from the viewpoint of filtration precision and filter life, a sintered filter medium is preferably used.

(iii) Gear Pump

To improve the thickness precision, it is important to decrease the fluctuation in the amount of the discharged resin and it is effective to provide a gear pump between the extruder and the die to feed a fixed amount of saturated norbornene resin through the gear pump. A gear pump is such that it includes a pair of gears—a drive gear and a driven gear—in mesh, and it drives the drive gear to rotate both the gears in mesh, thereby sucking the molten resin into the cavity through the suction opening formed on the housing and discharging a fixed amount of the resin through the discharge opening formed on the same housing. Even if there is a slight change in the resin pressure at the tip of the extruder, the gear pump absorbs the change, whereby the change in the resin pressure in the downstream portion of the film forming apparatus is kept very small, and the fluctuation in the film thickness is improved. The use of a gear pump makes it possible to keep the fluctuation of the resin pressure at the die within the range of ±1%.

To improve the fixed-amount feeding performance of the gear pump, a method can also be used in which the pressure before the gear pump is controlled to be constant by varying the number of revolution of the screw. Or the use of a high-precision gear pump is also effective in which three or more gears are used to eliminate the fluctuation in gear of a gear pump.

Other advantages of using a gear pump are such that it makes possible the film formation while reducing the pressure at the tip of the screw, which would be expected to reduce the energy consumption, prevent the increase in resin temperature, improve the transportation efficiency, decrease in the residence time of the resin in the extruder, and decrease the L/D of the extruder. Furthermore, when a filter is used to remove foreign matters, if a gear pump is not used, the amount of the resin fed from the screw can sometimes vary with increase in filtration pressure. However, this variation in the amount of resin fed from the screw can be eliminated by using a gear pump. On the other hand, disadvantages of using a gear pump are such that: it may increase the length of the equipment used, depending on the selection of equipment, which results in a longer residence time of the resin in the equipment; and the shear stress generated at the gear pump portion may cause the breakage of molecule chains. Thus, care must be taken when using a gear pump.

The residence time of the resin from entry to an extruder through a feeding port to exit from a die is preferably 2 minutes or more and 60 minutes or less, more preferably 3 minutes or more and 40 minutes or less, and much more preferably 4 minutes or more and 30 minutes or less.

If the flow of polymer circulating around the bearing of the gear pump is not smooth, the seal by the polymer at the driving portion and the bearing portion becomes poor, which may cause the problem of producing wide fluctuations in measurements and feeding and extruding pressures. Thus, the gear pump (particularly clearances thereof) should be designed to match to the melt viscosity of the saturated norbornene resin. In some cases, the portion of the gear pump where the saturated norbornene resin resides can be a cause of the resin's deterioration. Thus, preferably the gear pump has a structure which allows the residence time of the saturated norbornene resin to be as short as possible. The polymer tubes or adapters that connect the extruder with a gear pump or a gear pump with the die should be so designed that they allow the residence time of the saturated norbornene resin to be as short as possible. Furthermore, to stabilize the extrusion pressure, preferably the fluctuation in temperature is kept as small as possible. Generally, a band heater, which requires a lower plant cost, is often used for heating polymer tubes; however, it is more preferable to use a cast-in aluminum heater which is less susceptible to temperature fluctuation.

### (iv) Die

With the extruder constructed as above, the saturated norbornene resin is melted and the molten resin is continuously fed into a die, if necessary, through a filter or gear pump. Any type of commonly used die, such as T-die, fish-tail die or hanger coat die, may be used, as long as it allows the residence time of the molten resin in the die to be short. Further, a static mixer can be introduced right before the T-die to increase the uniformity of resin temperature. The clearance at the outlet of the T-die can generally be 1.0 to 5.0 times the film thickness, preferably 1.2 to 3 times the film thickness, and more preferably 1.3 to 2 times the film thickness. If the lip clearance is less than 1.0 time the film thickness, it is difficult to obtain a sheet having a good surface state by film formation. Conversely, if the lip clearance is more than 5.0 times the film thickness, undesirably the thickness precision of the sheet is decreased. A die is a very important apparatus to determine the thickness precision of the film to be formed, and thus, a die that can strictly control the film thickness is preferably used. Although commonly used dies can control the film thickness at intervals of 40 to 50 mm, dies of a type which can control the film thickness at intervals of 35 mm or less and more preferably at intervals of 25 mm or less are preferable. It is important to design a die that causes the least possible temperature irregularity and the least possible flow-rate irregularity across the width. The use of an automated thickness adjusting die, which measures the thickness of the film at downstream, calculates the thickness deviation and feeds back the calculated result for the die thickness adjustment, is also effective in decreasing fluctuations in thickness in the long-term continuous production of the film.

In manufacturing films, a single-layer film forming apparatus, which requires a lower plant cost, is generally used. However, depending on the case, it is also possible to use a multi-layer film forming apparatus to manufacture a film having 2 types or more of structure, in which an outer layer is formed as a functional layer. Generally, preferably a functional layer is laminated thin on the surface of the film, but the layer-layer ratio is not limited to any specific one.

### (v) Cast

According to the above described method, the molten resin extruded from the die in the form of a sheet is cooled and solidified on the casting drum to yield a film. At this stage, it is preferable to improve the adhesion between the casting drum and the melt-extruded sheet by using methods such as an electrostatic charging method, an air knife method, an air chamber method, a vacuum nozzle method and a touch roll method. Such adhesion improving methods may be applied to the whole surface of a melt-extruded sheet or a part thereof. Especially, a method called an edge pinning method involving an adhesion treatment of adhering onto the casting drum only the both edges of the film is often used, but the methods are not limited thereto.

Preferably the sheet of the molten resin is cooled little by little using a plurality of casting drums. Generally, cooling is often carried out using three cooling rolls; however, the number of the cooling rolls used is not limited to 3. The diameter of the rolls is preferably 50 mm or more and 5000 mm or less, more preferably 100 mm or more and 2000 mm or less, and much more preferably 150 mm or more and 1000 mm or less. The spacing between the multiple adjacent rolls is preferably 0.3 mm or more and 300 mm or less, on a face-to-face base, more preferably 1 mm or more and 100 mm or less, and much more preferably 3 mm or more and 30 mm or less.

The temperature of casting drums is preferably 60° C. or more and 160° C. or less, more preferably 70° C. or more and 150° C. or less, and much more preferably 80° C. or more and 140° C. or less. The cooled and solidified sheet is then stripped off from the casting drums, passed through nip rollers, and wound up. The wind-up speed is preferably from 10 m/min or more and 100 m/min or less, more preferably 15 m/min or more and 80 m/min or less, and much more preferably 20 m/min or more and 70 m/min or less.

The width of the film thus formed is preferably from 0.7 m or more and 5 m or less, more preferably 1 m or more and 4 m or less, and much more preferably 1.3 m or more and 3 m or less. The thickness of the unstretched film thus obtained is preferably 30 μm or more and 400 μm or less, more preferably 40 μm or more and 300 μm or less, and much more preferably 50 μm or more and 200 μm or less.

The thickness unevenness of the formed saturated norbornene film is preferably 0% or more and 2% or less in both the longitudinal and the transverse directions, more preferably 0% or more and 1.5% or less, and much more preferably 0% or more and 1% or less. The saturated norbornene film thus formed is then stretched by the above described method to obtain a saturated norbornene film of the present invention. When so-called touch roll method is used, the surface of the touch roll used may be made of resin, such as rubber or Teflon (registered trademark), or metal. A roll, called as flexible roll, can also be used whose surface gets a little depressed by the pressure of a metal roll having a decreased thickness when the flexible roll and the metal roll touch with each other, and their pressure contact area is increased.

The temperature of the touch roll is preferably from 60° C. or more and 160° C. or less, more preferably 70° C. or more and 150° C. or less, and much more preferably 80° C. or more and 140° C. or less.

### (vi) Winding Up

Preferably, the sheet thus obtained is wound up with its edges trimmed away. The portions having been trimmed off may be reused as a raw material for the same kind of film or a different kind of film, after undergoing grinding or, if necessary, after undergoing granulation, or depolymerization or re-polymerization. Any type of trimming cutter, such as a rotary cutter, shearing blade or knife, may be used. The material of the cutter may be either carbon steel or stainless steel. Generally, a carbide-tipped blade or ceramic blade is preferably used, because they have a long life and prevent chips from being generated.

It is also preferable, from the viewpoint of preventing the occurrence of scratches on the sheet, to provide, prior to winding up, a laminating film at least on one side of the sheet. Preferably, the wind-up tension is 1 kg/m (in width) or more and 50 kg/m (in width) or less, more preferably 2 kg/m (in width) or more and 40 kg/m (in width) or less, and much more preferably 3 kg/m (in width) or more and 20 kg/m (in width) or less. If the wind-up tension is lower than 1 kg/m (in width), it is difficult to wind up the film uniformly. Conversely, if the wind-up tension is higher than 50 kg/m (in width), undesirably the film is too tightly wound, whereby the appearance of wound film deteriorates, and the knot portion of the film is stretched due to the creep phenomenon, causing film rippling, or residual double refraction occurs due to the extension of the film. Preferably, the winding up is performed while detecting the wind-up tension by a tension controller provided midway along the line and controlling the same to be constant. When there is a difference in the film temperature depending on the spot on the film forming line, a slight difference in the film length can sometimes be created due to thermal expansion, and thus, it is necessary to adjust the draw ratio of the nip rolls so that tension higher than a prescribed one should not be applied to the film in the production line.

The winding-up of the film may be performed at a constant wind-up tension by a tension controller. However, a taper is preferably used according to the winding diameter to keep a proper wind-up tension. Generally, the wind-up tension is decreased little by little with increase in the winding diameter; however, it can be preferable to increase the wind-up tension with increase in the winding diameter, depending on the case.

The above winding method is a typical method in which the heat treatment of the present invention is performed off-line. When the heat treatment of the invention is performed on-line, winding must be controlled as described above.

Such a winding method is also applicable to the solution film forming method described below.

### (Solution Film Formation)

When the saturated norbornene resin of the present invention is dissolved in a solvent, the concentration of the resin in the solution is preferably 3 to 50% by weight, more preferably 5 to 40% by weight, and much more preferably 10 to 35% by weight. The viscosity of such a solution at room temperature is usually 1 to 1,000,000 (mPa·s), preferably 10 to 100,000 (mPa·s), more preferably 100 to 50,000 (mPa·s), and particularly preferably 1,000 to 40,000 (mPa·s).

Examples of solvent to be used include: aromatic solvents such as benzene, toluene and xylene; cellosolve solvents such as methyl cellosolve, ethyl cellosolve and 1-methoxy-2-propanol; ketone solvents such as diacetone alcohol, acetone, cyclohexanone, methyl ethyl ketone, 4-methyl-2-pentanone, cyclohexanone, ethyl cyclohexanone and 1,2-dimethylcyclohexane; ester solvents such as methyl lactate and ethyl lactate; halogen-containing solvents such as 2,2,3,3-tetrafluoro-1-propanol, methylene chloride and chloroform; ether solvents such as tetrahydrofuran and dioxane; alcohol solvents such as 1-pentanol and 1-butanol.

Solvents other than the above described ones may be used, but their SP values (solubility parameter) are usually in the range of 10 to 30 (MPal/2), preferably in the range of 10 to 25 (MPal/2), more preferably in the range of 15 to 25 (MPal/2), and particularly preferably in the range of 15 to 20 (MPal/2). Either one of the above described solvents alone or two or more kinds of them together can be used. When two or more kinds of solvents are used together, it is preferable to allow the SP value of the mixture to fall in the above described range. The SP value of a mixture can be obtained from the weight ratio of one kind of solvent to the other. In case of a mixture of two kinds of solvents, for example, the SP value of the mixture can be calculated using the following equation: SP value=W1·SP1+W2·SP2 where W1, W2 represent the weight fractions of the respective solvents and SP1, SP2 represent the SP values of the respective solvents.

A leveling agent can also be added to improve the surface smoothness of a saturated norbornene film. Any leveling agent can be used, as long as they are commonly-used ones. Examples of usable leveling agents include: fluorine-type nonionic surfactants, special acrylic resin-type leveling agents, and silicone-type leveling agents.

Commonly used methods of producing a saturated norbornene film of the present invention by solvent casting method may be a method including the steps of: applying the above described solution onto a substrate such as a metal drum, a steel belt, a polyester film of polyethylene terephthalate (PET), polyethylene naphthalate (PEN), or a polytetrafluoroethylene belt using a die or a coater; drying and removing a solvent thereof; and stripping off a film from the substrate.

The saturated norbornene film of the present invention can also be produced by: applying the resin solution onto a substrate using spray, brush, roll spin coat or dipping; drying and removing the solvent; and stripping off the film from the substrate. The application of the resin solution may be repeated to control the thickness or the surface smoothness of a film.

When a polyester film is used as a substrate, such a polyester film may be subjected to surface treatment before using. Methods of such surface treatment include: commonly used hydrophilization treatment; a method in which, for example, acrylic resin or sulfonate-group-containing resin is stacked by lamination or coating; and a method which uses corona discharge treatment, etc. to improve the hydrophilicity of the film surface.

The above described solvent casting method can employ any of commonly used drying (solvent removing) processes without particular limitation. For example, drying can be carried out by a process in which the film is passed through a drying furnace via a number of rollers. However, if air bubbles are generated, during the drying process, with the evaporation of a solvent, the properties of the film significantly deteriorate. Thus, in order to avoid this, it is preferable to allow the drying process to include two or more steps and control the temperature or air amount at each step.

The amount of the residual solvent in an optical film is usually 10% by weight or less, preferably 5% by weight or less, more preferably 1% by weight or less, and particularly preferably 0.5% by weight or less. Decreasing the amount of the residual solvent is preferable, because it allows trouble of adhesive traces to be further reduced.

The thickness of the saturated norbornene film of the present invention is preferably from 10 to 300 μm, more preferably 20 to 250 μm, and much more preferably 30 to 200 μm. The thickness distribution is preferably within ±8% relative to the average value, more preferably within ±5%, and much more preferably within ±3%. The variation in thickness per cm is usually 5% or less, preferably 3% or less, more preferably 1% or less, and particularly preferably 0.5% or less.

### (Processing of Saturated Norbornene Film)

The saturated norbornene film having undergone uniaxial stretching or biaxial stretching by the above described method may be used either alone or in combination with a polarizing plate. Or it may also be used with its surface provided with a liquid crystal layer, a layer with a controlled refractive index (low reflection layer) or a hard coat layer. These films can be achieved by carrying out the following steps.

### (i) Surface Treatment

The adhesion of saturated norbornene films to each functional layer (e.g. undercoat layer and back layer) can be improved by subjecting them to surface treatment. Examples of types of surface treatment applicable include: treatment using glow discharge, ultraviolet irradiation, corona discharge, flame, or acid or alkali. The glow discharge treatment mentioned herein may be treatment using low-temperature plasma generated in a low-pressure gas at 10⁻³ to 20 Torr. Further, plasma treatment at atmospheric pressure is also preferable. Plasma excitation gases are gases that undergo plasma excitation under the above described conditions. Examples of such gases include: argon, helium, neon, krypton, xenon, nitrogen, carbon dioxide, flons such as tetrafluoromethane, and the mixtures thereof. These are described in detail in Journal of Technical Disclosure (Laid-Open No. 2001-1745, issued on Mar. 15, 2001, by Japan Institute of Invention and Innovation), pages 30-32. In the plasma treatment at atmospheric pressure, which has attracted considerable attention in recent years, for example, irradiation energy of 20 to 500 Kgy is used at 10 to 1000 Kev, and preferably irradiation energy of 20 to 300 Kgy is used at 30 to 500 Kev.

Of these types of surface treatment, particularly preferable are glow discharge treatment, corona discharge treatment and flame treatment.

It is preferable to provide an undercoat layer for adhesion to the functional layer. The undercoat layer may be applied after carrying out the above described surface treatment or without the surface treatment. The details of the undercoat layers are described in Journal of Technical Disclosure (Laid-Open No. 2001-1745, issued on Mar. 15, 2001, by Japan Institute of Invention and Innovation), page 32.

These surface-treatment step and under-coat step can be incorporated into the final part of the film forming step, or they can be performed independently, or they can be performed in the functional-layer providing process described below.

### (ii) Providing Functional Layer

Preferably, the saturated norbornene film according to the embodiment of the present invention is combined with any one of the functional layers described in detail in Journal of Technical Disclosure (Laid-Open No. 2001-1745, issued on Mar. 15, 2001, by Japan Institute of Invention and Innovation), pages 32-45. Particularly preferable is providing a polarizing layer (polarizer), optical compensation layer (optical compensation film), or antireflection layer (antireflection film).

### (A) Providing Polarizing Layer (Preparation of Polarizer)

### (A-1) Materials Used for Polarizing Layer

At the present time, generally, commercially available polarizing layers are prepared by immersing a stretched polymer in a solution of iodine or a dichroic dye in a bath so that the iodine or dichroic dye penetrates into the binder. Coating-type of polarizing films, represented by those manufactured by Optiva Inc., is also available as a polarizing film. Iodine or a dichroic dye in the polarizing film develops polarizing properties when its molecules are oriented in a binder. Examples of dichroic dyes applicable include: azo dye, stilbene dye, pyrazolone dye, triphenylmethane dye, quinoline dye, oxazine dye, thiazine dye or anthraquinone dye. The dichroic dye used is preferably water-soluble. The dichroic dye used preferably has a hydrophilic substitute (e.g. sulfo, amino, or hydroxyl). Example of such dichroic dyes includes: compounds described in Journal of Technical Disclosure, Laid-Open No. 2001-1745, page 58, (issued on Mar. 15, 2001, by Japan Institute of Invention and Innovation).

Any polymer which is crosslinkable in itself or which is crosslinkable in the presence of a crosslinking agent can be used as a binder for polarizing films. And more than one combination thereof can also be used as a binder. Examples of binders applicable include: compounds described in Japanese Patent Application Laid-Open No. 8-338913, paragraph [0022], such as methacrylate copolymers, styrene copolymers, polyolefin, polyvinyl alcohol and modified polyvinyl alcohol, poly(N-methylolacrylamide), polyester, polyimide, vinyl acetate copolymer, carboxymethylcellulose, and polycarbonate. Silane coupling agents can also be used as a polymer. Preferable are water-soluble polymers (e.g. poly(N-methylolacrylamide), carboxymethylcellulose, gelatin, polyvinyl alcohol and modified polyvinyl alcohol), more preferable are gelatin, polyvinyl alcohol and modified polyvinyl alcohol, and most preferable are polyvinyl alcohol and modified polyvinyl alcohol. Use of two kinds of polyvinyl alcohol or modified polyvinyl alcohol having different polymerization degrees in combination is particularly preferable. The saponification degree of polyvinyl alcohol is preferably 70 to 100% and more preferably 80 to 100%. The polymerization degree of polyvinyl alcohol is preferably 100 to 5000. Details of modified polyvinyl alcohol are described in Japanese Patent Application Laid-Open Nos. 8-338913, 9-152509 and 9-316127. For polyvinyl alcohol and modified polyvinyl alcohol, two or more kinds may be used in combination.

Preferably, the minimum of the binder thickness is 10 μm. For the maximum of the binder thickness, from the viewpoint of light leakage of liquid crystal displays, preferably the binder has the smallest possible thickness. The thickness of the binder is preferably equal to or smaller than that of currently commercially available polarizer (about 30 μm), more preferably 25 μm or smaller, and much more preferably 20 μm or smaller.

The binder for polarizing films may be crosslinked. Polymer or monomer that has a crosslinkable functional group may be mixed into the binder. Or a crosslinkable functional group may be provided to the binder polymer itself. Crosslinking reaction is allowed to progress by means of light, heat or pH changes, and a binder having a crosslinked structure can be formed by crosslinking reaction. Examples of crosslinking agents applicable are described in U.S. Pat. No. (Reissued) 23,297. Boron compounds (e.g. boric acid and borax) may also be used as a crosslinking agent. The amount of the crosslinking agent added to the binder is preferably 0.1 to 20% by mass of the binder. This allows polarizing devices to have good orientation characteristics and polarizing films to have good damp heat resistance.

The amount of the unreacted crosslinking agent after completion of the crosslinking reaction is preferably 1.0% by mass or less and more preferably 0.5% by mass or less. Restraining the unreacted crosslinking agent to such an amount improves the weatherability of the binder.

### (A-2) Stretching of Polarizing Layer

Preferably, a polarizing film is dyed with iodine or a dichroic dye after undergoing stretching (stretching process) or rubbing (rubbing process).

In the stretching process, preferably the stretching magnification is 2.5 to 30.0 and more preferably 3.0 to 10.0. Stretching can be dry stretching, which is performed in the air. Stretching can also be wet stretching, which is performed while immersing a film in water. The stretching magnification in the dry stretching is preferably 2.5 to 5.0, while the stretching magnification in the wet stretching is preferably 3.0 to 10.0. Stretching may be performed parallel to the MD direction (parallel stretching) or in an oblique (oblique stretching). These stretching operations may be performed at one time or in several installments. Stretching can be performed more uniformly even in high-ratio stretching if it is performed in several installments.

### a) Parallel Stretching Process

Prior to stretching, a PVA film is swelled. The degree of swelling is 1.2 to 2.0 (ratio of mass before swelling to mass after swelling). After this swelling operation, the PVA film is stretched in a water-based solvent bath or in a dye bath in which a dichroic substance is dissolved at a bath temperature of 15 to 50° C., preferably 17 to 40° C. while continuously conveying the film via a guide roll etc. Stretching can be accomplished in such a manner as to grip the PVA film with 2 pairs of nip rolls and control the conveying speed of nip rolls so that the conveying speed of the latter pair of nip rolls is higher than that of the former pair of nip rolls. The stretching magnification is based on the length of PVA film after stretching/the length of the same in the initial state ratio (hereinafter the same), and from the viewpoint of the above described advantages, the stretching magnification is preferably 1.2 to 3.5 and more preferably 1.5 to 3.0. After this stretching operation, the film is dried at 50° C. to 90° C. to obtain a polarizing film.

### b) Oblique Stretching Process

Oblique stretching can be performed by the method described in Japanese Patent Application Laid-Open No. 2002-86554 in which a tenter that projects on a tilt is used. This stretching is performed in the air; therefore, it is necessary to allow a film to contain water in advance so that the film is easy to stretch. The water content in the film is preferably 5% or more and 100% or less and more preferably 10% or more and 100% or less.

The temperature during the stretching is preferably 40° C. or more and 90° C. or less and more preferably 50° C. or more and 80° C. or less. The humidity is preferably 50% rh or more and 100% rh or less, more preferably 70% rh or more and 100% rh or less, and much more preferably 80% rh or more and 100% rh or less. The traveling speed of the film across the length is preferably 1 m/min. or more and more preferably 3 n/min. or more.

After completing the stretching, the film is dried at 50° C. or more and 100° C. or less and preferably 60° C. or more and 90° C. or less for 0.5 minutes or more and 10 minutes or less and more preferably 1 minute or more and 5 minutes or less.

The absorbing axis of the polarizing film thus obtained is preferably 10 degrees to 80 degrees, more preferably 30 degrees to 60 degrees, and much more preferably substantially 45 degrees (40 degrees to 50 degrees).

### (A-3) Lamination

The above-described saturated norbornene film having undergone surface treatment and the polarizing layer prepared by stretching are laminated to prepare a polarizing plate. They are preferably laminated so that the angle between the direction of the saturated norbornene film casting axis and the direction of stretching axis of the polarizing plate is 45 degrees.

An adhesive for the lamination is not particularly limited, but examples of adhesives include PVA resins (including modified PVA such as acetoacetyl, sulfonic, carboxyl or oxyalkylene group), aqueous solutions of boron compounds, and epoxy adhesives. Of these adhesives, PVA resins and epoxy adhesives are preferable. The thickness of the adhesive layer is preferably 0.01 to 10 μm and particularly preferably 0.05 to 5 μm, after being dried.

The polarizing plate thus obtained preferably has a higher light transmittance and a higher degree of polarization. The light transmittance of the polarizing plate is preferably in the range of 30 to 50% for a light at a wavelength of 550 nm, more preferably in the range of 35 to 50%, and most preferably in the range of 40 to 50%. The degree of polarization is preferably in the range of 90 to 100% for a light at a wavelength of 550 nm, more preferably in the range of 95 to 100%, and most preferably in the range of 99 to 100%.

The polarizing plate thus obtained can be laminated with a λ/4 plate to create circularly polarized light. In this case, they are laminated so that the angle between the slow axis of the λ/4 plate and the absorbing axis of the polarizing plate is 45 degrees. Any λ/4 plate can be used to create circularly polarized light; however, preferably one having such wavelength-dependency that retardation is decreased with decrease in wavelength is used. More preferably, a polarizing film having an absorbing axis which tilts 20 degrees to 70 degrees in the longitudinal direction and a λ/4 plate that includes an optically anisotropic layer made up of a liquid crystalline compound are used.

### (B) Providing Optical Compensation Layer (Preparation of Optical Compensation Film)

An optically anisotropic layer is used for compensating the liquid crystalline compound in a liquid crystal cell in black display by a liquid crystal display device. It is prepared by forming an orientation film on a saturated norbornene film and providing an optically anisotropic layer on the orientation film.

### (B-1) Orientation Film

An orientation film is provided on the above described saturated norbornene film which has undergone surface treatment. This film has the function of specifying the orientation direction of liquid crystalline molecules. However, this film is not necessarily indispensable constituent of the present invention. This is because a liquid crystalline compound plays the role of the orientation film, as long as the oriented state of the liquid crystalline compound is fixed after it undergoes orientation treatment. In other words, the sheets of polarizer of the present invention can also be prepared by transferring only the optically anisotropic layer on the orientation film, where the orientation state is fixed, on the polarizer.

An orientation film can be provided using a technique such as rubbing of an organic compound (preferably polymer), oblique deposition of an inorganic compound, formation of a micro-groove-including layer, or built-up of an organic compound (e.g. ω-tricosanic acid, dioctadecyl methyl ammonium chloride, methyl stearate) by Langmur-Blodgett technique (LB membrane). Orientation films in which orientation function is produced by the application of electric field, electromagnetic field or light irradiation are also known.

Preferably, the orientation film is formed by rubbing of polymer. As a general rule, the polymer used for the orientation film has a molecular structure having the function of orienting liquid crystalline molecules.

In the embodiment of the present invention, preferably the orientation film has not only the function of orienting liquid crystalline molecules, but also the function of combining a side chain having a crosslinkable functional group (e.g. double bond) with the main chain or the function of introducing a crosslinkable functional group having the function of orienting liquid crystalline molecules into a side chain.

Either polymer which is crosslinkable in itself or polymer which is crosslinkable in the presence of a crosslinking agent can be used for the orientation film. And a plurality of the combinations thereof can also be used. Examples of such polymer include: those described in Japanese Patent Application Laid-Open No. 8-338913, paragraph [0022], such as methacrylate copolymers, styrene copolymers, polyolefin, polyvinyl alcohol and modified polyvinyl alcohol, poly(N-methylolacrylamide), polyester, polyimide, vinyl acetate copolymer, carboxymethylcellulose, and polycarbonate. Silane coupling agents can also be used as a polymer. Preferable are water-soluble polymers (e.g. poly(N-methylolacrylamide), carboxymethylcellulose, gelatin, polyvinyl alcohol and modified polyvinyl alcohol), more preferable are gelatin, polyvinyl alcohol and modified polyvinyl alcohol, and most preferable are polyvinyl alcohol and modified polyvinyl alcohol. Use of two kinds of polyvinyl alcohol or modified polyvinyl alcohol having different polymerization degrees in combination is particularly preferable. The saponification degree of polyvinyl alcohol is preferably 70 to 100% and more preferably 80 to 100%. The polymerization degree of polyvinyl alcohol is preferably 100 to 5000.

Side chains having the function of orienting liquid crystal molecules generally have a hydrophobic group as a functional group. The specific kind of the functional group is determined depending on the kind of liquid crystalline molecules and the oriented state required.

For example, a denatured group of modified polyvinyl alcohol can be introduced by copolymerization denaturation, chain transfer denaturation or block polymerization denaturation. Examples of denatured groups include: hydrophilic groups (e.g. carboxylic, sulfonic, phosphonic, amino, ammonium, amide and thiol groups); hydrocarbon groups with 10 to 100 carbon atoms; hydrocarbon groups substituted with a fluorine atom; thioether groups; polymerizable groups (e.g. unsaturated polymerizable groups, epoxy group, azirinyl group); and alkoxysilyl groups (e.g. trialkoxy, dialkoxy, monoalkoxy). Specific examples of these modified polyvinyl alcohol compounds include: those described in Japanese Patent Application Laid-Open No. 2000-155216, paragraphs [0022] to [0145], Japanese Patent Application Laid-Open No. 2002-62426, paragraphs [0018] to [0022].

Combining a side chain having a crosslinkable functional group with the main chain of the polymer of an orientation film or introducing a crosslinkable functional group into a side chain having the function of orienting liquid crystal molecules makes it possible to copolymerize the polymer of the orientation film and the polyfunctional monomer contained in the optically anisotropic layer. As a result, not only the molecules of the polyfunctional monomer, but also the molecules of the polymer of the orientation film and those of the polyfunctional monomer and the polymer of the orientation film are covalently firmly bonded together. Thus, introduction of a crosslinkable functional group into the polymer of an orientation film enables remarkable improvement in the strength of optical compensation films.

The crosslinkable functional group of the polymer of the orientation film preferably has a polymerizable group, like the polyfunctional monomer. Specific examples of such crosslinkable functional groups include: those described in Japanese Patent Application Laid-Open No. 2000-155216, paragraphs [0080] to [0100]. The polymer of the orientation film can be crosslinked using a crosslinking agent, besides the above described crosslinkable functional groups.

Examples of crosslinking agents applicable include: aldehyde; N-methylol compounds; dioxane derivatives; compounds that function by the activation of their carboxyl group; activated vinyl compounds; activated halogen compounds; isoxazole; and dialdehyde starch. Two or more kinds of crosslinking agents may be used in combination. Specific examples of such crosslinking agents include: compounds described in Japanese Patent Application Laid-Open No. 2002-62426, paragraphs [0023] to [0024]. Aldehyde, which is highly reactive, particularly glutaraldehyde is preferably used as a crosslinking agent.

The amount of the crosslinking agent added is preferably 0.1 to 20% by mass of the polymer and more preferably 0.5 to 15% by mass. The amount of the unreacted crosslinking agent remaining in the orientation film is preferably 1.0% by mass or less and more preferably 0.5% by mass or less. Controlling the amount of the crosslinking agent and unreacted crosslinking agent in the above described manner makes it possible to obtain a sufficiently durable orientation film, in which reticulation does not occur even after it is used in a liquid crystal display for a long time or it is left in an atmosphere of high temperature and high humidity for a long time.

Basically, an orientation film can be formed by: coating the above described polymer, as a material for forming an orientation film, on a transparent substrate containing a crosslinking agent; heat drying (crosslinking) the polymer; and rubbing the same. The crosslinking reaction may be carried out at any time after the polymer is applied to the transparent substrate, as described above. When a water-soluble polymer, such as polyvinyl alcohol, is used as the material for forming an orientation film, the coating solution is preferably a mixed solvent of an organic solvent having an anti-foaming function (e.g. methanol) and water. The mixing ratio by mass is preferably such that water:methanol=0:100 to 99:1 and more preferably 0:100 to 91:9. The use of such a mixed solvent suppresses the generation of foam, thereby significantly decreasing defects not only in the orientation film, but also on the surface of the optically anisotropic layer.

As a coating method for coating an orientation film, spin coating, dip coating, curtain coating, extrusion coating, rod coating or roll coating is preferably used. Particularly preferably used is rod coating. The thickness of the film after drying is preferably 0.1 to 10 μm. The heat drying can be carried out at 20° C. to 110° C. To achieve sufficient crosslinking, preferably the heat drying is carried out at 60° C. to 100° C. and particularly preferably at 80° C. to 100° C. The drying time can be 1 minute to 36 hours, but preferably it is 1 minute to 30 minutes. Preferably, the pH of the coating solution is set to a value optimal to the crosslinking agent used. When glutaraldehyde is used, the pH is 4.5 to 5.5 and particularly preferably 5.

The orientation film is provided on the transparent substrate or on the above described undercoat layer. The orientation film can be obtained by crosslinking the polymer layer and providing rubbing treatment on the surface of the polymer layer, as described above.

The above described rubbing treatment can be carried out using a treatment method widely used in the treatment of liquid crystal orientation in LCD. Specifically, orientation can be obtained by rubbing the surface of the orientation film in a fixed direction with paper, gauze, felt, rubber or nylon, polyester fiber and the like. Generally the treatment is carried out by repeating rubbing a several times using a cloth in which fibers of uniform length and diameter have been uniformly transplanted.

In the rubbing treatment industrially carried out, rubbing is performed by bringing a rotating rubbing roll into contact with a running film including a polarizing layer. The circularity, cylindricity and deviation (eccentricity) of the rubbing roll are preferably 30 μm or less respectively. The wrap angle of the film wrapping around the rubbing roll is preferably 0.1 to 90°. However, as described in Japanese Patent Application Laid-Open No. 8-160430, if the film is wrapped around the rubbing roll at 360° or more, stable rubbing treatment is ensured. The conveying speed of the film is preferably 1 to 100 m/min. Preferably, the rubbing angle is properly selected from the range of 0 to 60°. When the orientation film is used in liquid crystal displays, the rubbing angle is preferably 40° to 50° and particularly preferably 45°.

The thickness of the orientation film thus obtained is preferably in the range of 0.1 to 10 μm.

Then, liquid crystalline molecules of the optically anisotropic layer are oriented on the orientation film. After that, if necessary, the polymer of the orientation film and the polyfunctional monomer contained in the optically anisotropic layer are reacted, or the polymer of the orientation film is crosslinked using a crosslinking agent.

The liquid crystalline molecules used for the optically anisotropic layer include: rod-shaped liquid crystalline molecules and discotic liquid crystalline molecules. The rod-shaped liquid crystalline molecules and discotic liquid crystalline molecules may be either high-molecular-weight liquid crystalline molecules or low-molecular-weight liquid crystalline molecules, and they include low-molecule liquid crystalline molecules which have undergone crosslinking and do not show liquid crystallinity any more.

### (B-2) Rod-Shaped Liquid Crystalline Molecules

Examples of rod-shaped liquid crystalline molecules preferably used include: azomethines, azoxys, cyanobiphenyls, cyanophenyl esters, benzoate esters, cyclohexane carboxylic acid phenyl esters, cyanophenyl cyclohexanes, cyano-substituted phenyl pyrimidines, alkoxy-substituted phenyl pyrimidines, phenyl dioxanes, tolans, and alkenyl cyclohexyl benzonitriles.

Rod-shaped liquid crystalline molecules also include metal complexes. Liquid crystal polymer that includes rod-shaped liquid crystalline molecules in its repeating unit can also be used as rod-shaped liquid crystalline molecules. In other words, rod-shaped liquid crystalline molecules may be bonded to (liquid crystal) polymer.

Rod-shaped liquid crystalline molecules are described in Kikan Kagaku Sosetsu (Survey of Chemistry, Quarterly), Vol. 22, Chemistry of Liquid Crystal (1994), edited by The Chemical Society of Japan, Chapters 4, 7 and 11 and in Handbook of Liquid Crystal Devices, edited by 142th Committee of Japan Society for the Promotion of Science, Chapter 3.

The index of birefringence of the rod-shaped liquid crystalline molecules is preferably in the range of 0.001 to 0.7.

To allow the oriented state to be fixed, preferably the rod-shaped liquid crystalline molecules have a polymerizable group. As such a polymerizable group, a radically polymerizable unsaturated group or cationically polymerizable group is preferable. Specific examples of such polymerizable groups include: polymerizable groups and polymerizable liquid crystal compounds described in Japanese Patent Application Laid-Open No. 2002-62427, paragraphs [0064] to [0086].

### (B-3) Discotic Liquid Crystalline Molecules

Discotic liquid crystalline molecules include: benzene derivatives described in the research report by C. Destrade et al., Mol. Cryst. Vol. 71, p. 111 (1981); truxene derivatives described in the research report by C. Destrade et al., Mol. Cryst. Vol. 122, p. 141 (1985) and Physics lett, A, Vol. 78, p. 82 (1990); cyclohexane derivatives described in the research report by B. Kohne et al., Angew. Chem. Vol. 96, p. 70 (1984); and azacrown or phenylacetylene macrocycles described in the research report by J. M. Lehn et al., J. Chem. Commun., p. 1794 (1985) and in the research report by J. Zhang et al., J. Am. Chem. Soc. Vol. 116, p. 2655 (1994).

Discotic liquid crystalline molecules also include liquid crystalline compounds having a structure in which a straight-chain alkyl group, an alkoxy group and a substituted benzoyloxy group are substituted radially as the side chains of the mother nucleus at the center of the molecules. Preferably, the compounds are such that their molecules or groups of molecules have rotational symmetry and they can provide an optically anisotropic layer with a fixed orientation. In the ultimate state of the optically anisotropic layer formed of discotic liquid crystalline molecules, the compounds contained in the optically anisotropic layer are not necessarily discotic liquid crystalline molecules. The ultimate state of the optically anisotropic layer also contain compounds such that they are originally of low-molecular-weight discotic liquid crystalline molecules having a group reactive with heat or light, but undergo polymerization or crosslinking by heat or light, thereby becoming higher-molecular-weight molecules and losing their liquid crystallinity. Examples of preferred discotic liquid crystalline molecules are described in Japanese Patent Application Laid-Open No. 8-50206. And the details of the polymerization of discotic liquid crystalline molecules are described in Japanese Patent Application Laid-Open No. 8-27284.

To fix the discotic liquid crystalline molecules by polymerization, it is necessary to bond a polymerizable group, as a substitute, to the discotic core of the discotic liquid crystalline molecules. Compounds in which their discotic core and a polymerizable group are bonded to each other via a linking group are preferably used. With such compounds, the oriented state is maintained during the polymerization reaction. Examples of such compounds include: those described in Japanese Patent Application Laid-Open No. 2000-155216, paragraphs [0151] to [0168].

In hybrid orientation, the angle between the long axis (disc plane) of the discotic liquid crystalline molecules and the plane of the polarizing film increases or decreases, with increase in the distance from the plane of the polarizing film in the depth direction of the optically anisotropic layer. Preferably, the angle decreases with increase in the distance. The possible changes in angle include: continuous increase, continuous decrease, intermittent increase, intermittent decrease, change including both continuous increase and continuous decrease, and intermittent change including increase and decrease. The intermittent changes include the area midway across the thickness where the tilt angle does not change. Even if the change includes the area where the angle does not change, it does not matter as long as the angle increases or decreased as a whole. Preferably, the angle changes continuously.

Generally, the average direction of the long axis of the discotic liquid crystalline molecules on the polarizing film side can be adjusted by selecting the type of discotic liquid crystalline molecules or the material for the orientation film, or by selecting the method of rubbing treatment. On the other hand, generally the direction of the long axis (disc plane) of the discotic liquid crystalline molecules on the surface side (on the air side) can be adjusted by selecting the type of discotic liquid crystalline molecules or the type of the additives used together with the discotic liquid crystalline molecules. Examples of additives used with the discotic liquid crystalline molecules include: plasticizers, surfactants, polymerizable monomers, and polymers. The degree of the change in orientation in the long axis direction can also be adjusted by selecting the type of the liquid crystalline molecules and that of additives, like the above described cases.

### (B-4) Other Compositions of Optically Anisotropic Layer

Use of plasticizers, surfactants, polymerizable monomers, etc. together with the above described liquid crystalline molecules makes it possible to improve the uniformity of the coating film, the strength of the film and the orientation of liquid crystalline molecules. Preferably, such additives are compatible with the liquid crystalline molecules, and they can change the tilt angle of the liquid crystalline molecules or do not inhibit the orientation of the liquid crystalline molecules.

Examples of polymerizable monomers include radically polymerizable or cationically polymerizable compounds. Preferable are radically polymerizable polyfunctional monomers which are copolymerizable with the above described polymerizable-group containing liquid crystalline compounds. Specific examples are those described in Japanese Patent Application Laid-Open No. 2002-296423, paragraphs [0018] to [0020]. The amount of the above described compounds added is generally in the range of 1 to 50% by mass of the discotic liquid crystalline molecules and preferably in the range of 5 to 30% by mass.

Examples of surfactants include traditionally known compounds; however, fluorine compounds are particularly preferable. Specific examples of fluorine compounds include compounds described in Japanese Patent Application Laid-Open No. 2001-330725, paragraphs [0028] to [0056].

Preferably, polymers used together with the discotic liquid crystalline molecules can change the tilt angle of the discotic liquid crystalline molecules.

Examples of polymers applicable include cellulose esters. Examples of preferred cellulose esters include those described in Japanese Patent Application Laid-Open No. 2000-155216, paragraphs [0178]. Not to inhibit the orientation of the liquid crystalline molecules, the amount of the above described polymers added is preferably in the range of 0.1 to 10% by mass of the liquid crystalline molecules and more preferably in the range of 0.1 to 8% by mass.

The discotic nematic liquid crystal phase-solid phase transition temperature of the discotic liquid crystalline molecules is preferably 70 to 300° C. and more preferably 70 to 170° C.

### (B-5) Formation of Optically Anisotropic Layer

An optically anisotropic layer can be formed by coating the surface of the orientation film with a coating fluid that contains liquid crystalline molecules and, if necessary, polymerization initiator or any other ingredients described later.

As a solvent used for preparing the coating fluid, an organic solvent is preferably used. Examples of organic solvents applicable include: amides (e.g. N,N-dimethylformamide); sulfoxides (e.g. dimethylsulfoxide); heterocycle compounds (e.g. pyridine); hydrocarbons (e.g. benzene, hexane); alkyl halides (e.g. chloroform, dichloromethane, tetrachloroethane); esters (e.g. methyl acetate, butyl acetate); ketones (e.g. acetone, methyl ethyl ketone); and ethers (e.g. tetrahydrofuran, 1,2-dimethoxy ethane). Alkyl halides and ketones are preferably used. Two or more kinds of organic solvent can be used in combination.

Such a coating fluid can be applied by a known method (e.g. wire bar coating, extrusion coating, direct gravure coating, reverse gravure coating or die coating method).

The thickness of the optically anisotropic layer is preferably 0.1 to 20 μm, more preferably 0.5 to 15 μm, and most preferably 1 to 10 μm.

### (B-6) Fixation of Orientation State of Liquid Crystalline Molecules

The oriented state of the oriented liquid crystalline molecules can be maintained and fixed. Preferably, the fixation is performed by polymerization. Types of polymerization include: heat polymerization using a heat polymerization initiator and photopolymerization using a photopolymerization initiator. Photopolymerization is preferred.

Examples of photopolymerization initiators include: α-carbonyl compounds (described in U.S. Pat. Nos. 2,367,661 and 2,367,670); acyloin ethers (described in U.S. Pat. No. 2,448,828); α-hydrocarbon-substituted aromatic acyloin compounds (U.S. Pat. No. 2,722,512); multi-nucleus quinone compounds (described in U.S. Pat. Nos. 3,046,127 and 2,951,758); combinations of triarylimidazole dimer and p-aminophenyl ketone (described in U.S. Pat. No. 3,549,367); acridine and phenazine compounds (described in Japanese Patent Application Laid-Open No. 60-105667 and U.S. Pat. No. 4,239,850); and oxadiazole compounds (described in U.S. Pat. No. 4,212,970).

The amount of the photopolymerization initiators used is preferably in the range of 0.01 to 20% by mass of the solid content of the coating fluid and more preferably in the range of 0.5 to 5% by mass.

Light irradiation for the polymerization of liquid crystalline molecules is preferably performed using ultraviolet light.

Irradiation energy is preferably in the range of 20 mJ/cm² to 50 J/cm², more preferably 20 to 5000 mJ/cm², and much more preferably 100 to 800 mJ/cm². To accelerate the photopolymerization, light irradiation may be performed under heat. A protective layer may be provided on the surface of the optically anisotropic layer.

Combining the optical compensation film with a polarizing layer is also preferable. Specifically, an optically anisotropic layer is formed on a polarizing film by coating the surface of the polarizing film with the above described coating fluid for an optically anisotropic layer. As a result, thin polarizer, in which stress generated with the dimensional change of polarizing film (distortion×cross-sectional area×modulus of elasticity) is small, can be prepared without using a polymer film between the polarizing film and the optically anisotropic layer. Installing the polarizer according to the present invention in a large-sized liquid crystal display device enables high-quality images to be displayed without causing problems such as light leakage.

Preferably, stretching is performed while keeping the tilt angle of the polarizing layer and the optical compensation layer to the angle between the transmission axis of the two sheets of polarizer laminated on both sides of a liquid crystal cell constituting LCD and the longitudinal or transverse direction of the liquid crystal cell. Generally the tilt angle is 45°. However, in recent years, transmissive-, reflective-, and semi-transmissive-liquid crystal display devices have been developed in which the tilt angle is not always 45°, and thus, it is preferable to adjust the stretching direction arbitrarily to the design of each LCD.

### (B-7) Liquid Crystal Display Devices

Liquid crystal modes, in which the above described optical compensation film is used will be described.

### (TN-Mode Liquid Crystal Display Devices)

TN-mode liquid crystal display devices are most commonly used as a color TFT liquid crystal display device and described in a large number of documents. The oriented state in a TN-mode liquid crystal cell in the black state is such that the rod-shaped liquid crystalline molecules stand in the middle of the cell while the rod-shaped liquid crystalline molecules lie near the substrates of the cell.

### (OCB-Mode Liquid Crystal Display Devices)

An OCB-mode liquid crystal cell is a bend orientation mode liquid crystal cell where the rod-shaped liquid crystalline molecules in the upper part of the liquid cell and those in the lower part of the liquid cell are oriented in substantially opposite directions (symmetrically). Liquid crystal display devices using a bend orientation mode liquid crystal cell are disclosed in U.S. Pat. Nos. 4,583,825 and 5,410,422. A bend orientation mode liquid crystal cell has a self-optical-compensation function since the rod-shaped liquid crystalline molecules in the upper part of the liquid cell and those in the lower part are symmetrically oriented. Thus, this liquid crystal mode is also referred to as OCB (Optically Compensatory Bend) liquid crystal mode.

Like in the TN-mode cell, the oriented state in an OCB-mode liquid crystal cell in the black state is also such that the rod-shaped liquid crystalline molecules stand in the middle of the cell while the rod-shaped liquid crystalline molecules lie near the substrates of the cell.

### (VA-Mode Liquid Crystal Display Devices)

VA-mode liquid crystal cells are characterized in that in the cells, rod-shaped liquid crystalline molecules are oriented substantially vertically when no voltage is applied. The Va-Mode Liquid Crystal Cells Include: (1) a Va-Mode Liquid Crystal Cell in a narrow sense where rod-shaped liquid crystalline molecules are oriented substantially vertically when no voltage is applied, while they are oriented substantially horizontally when a voltage is applied (Japanese Patent Application Laid-Open No. 2-176625); (2) an MVA-mode liquid crystal cell obtained by introducing multi-domain switching of liquid crystal into a VA-mode liquid crystal cell to obtain wider viewing angle, (SID 97, Digest of Tech. Papers (Proceedings) 28 (1997) 845), (3) an n-ASM-mode liquid crystal cell where rod-shaped liquid crystalline molecules undergo substantially vertical orientation when no voltage is applied, while they undergo twisted multi-domain orientation when a voltage is applied (Proceedings 58 to 59 (1998), Symposium, Japanese Liquid Crystal Society); and (4) a SURVAUVAL-mode liquid crystal cell (reported in LCD international 98).

### (IPS-Mode Liquid Crystal Display Devices)

IPS-mode liquid crystal cells are characterized in that in the cells, rod-shaped liquid crystalline molecules are oriented substantially horizontally in plane when no voltage is applied and switching is performed by changing the orientation direction of the liquid crystal in accordance with the presence or absence of application of voltage. Specific Examples of IPS-Mode Liquid Crystal Cells Applicable Include Those Described in Japanese Patent Application Laid-Open Nos. 2004-365941, 2004-12731, 2004-215620, 2002-221726, 2002-55341 and 2003-195333.

### (Other Modes of Liquid Crystal Display Devices)

In ECB-mode and STN-mode liquid crystal display devices, optical compensation can also be achieved with the above described logic.

### (C) Providing Antireflection Layer (Antireflection Film)

Generally an antireflection film is made up of: a low-refractive-index layer which also functions as a stainproof layer; and at least one layer having a refractive index higher than that of the low-refractive-index layer (i.e. high-refractive-index layer and/or intermediate-refractive-index layer) provided on a transparent substrate.

Methods of forming a multi-layer thin film as a laminate of transparent thin films of inorganic compounds (e.g. metal oxides) having different refractive indices include: chemical vapor deposition (CVD); physical vapor deposition (PVD); and a method in which a film of a colloid of metal oxide particles is formed by a sol-gel method from a metal compound such as a metal alkoxide and the formed thin film is subjected to post-treatment (ultraviolet light irradiation: Japanese Patent Application Laid-Open No. 9-157855, plasma treatment: Japanese Patent Application Laid-Open No. 2002-327310).

On the other hand, there are proposed a various antireflection films, as highly productive antireflection films, which are formed by laminate-coating thin films having inorganic particles dispersed in a matrix.

There is also provided an antireflection film including an antireflection layer provided with anti-glare properties, which is formed by using an antireflection film formed by coating as described above and providing the outermost surface of the film with fine irregularities.

The saturated norbornene film of the present invention is applicable to antireflection films formed by any of the above described methods, but particularly preferable is the antireflection film formed by coating (coating type antireflection film).

### (C-1) Layer Configuration of Coating-Type Antireflection Film

An antireflection film having at least on its substrate a layer construction of: intermediate-refractive-index layer, high-refractive-index layer and low-refractive-index layer (outermost layer) in this order is designed to have a refractive index satisfying the following relationship.

Refractive index of high-refractive-index layer>refractive index of intermediate-refractive-index layer>refractive index of transparent substrate>refractive index of low-refractive-index layer. Also, a hard coat layer may be provided between the transparent substrate and the intermediate-refractive-index layer. Further, the antireflection film may be made up of: intermediate-refractive-index hard coat layer, high-refractive-index layer and low-refractive-index layer.

Examples of such antireflection films include: those described in Japanese Patent Application Laid-Open Nos. 8-122504, 8-110401, 10-300902, 2002-243906 and 2000-111706. Other functions may also be imparted to each layer. There are proposed, for example, antireflection films that include a stainproofing low-refractive-index layer or anti-static high-refractive-index layer (e.g. Japanese Patent Application Laid-Open Nos. 10-206603 and 2002-243906).

The haze of the antireflection film is preferably 5% or less and more preferably 3% or less. The strength of the film is preferably H or more, by pencil hardness test in accordance with JIS K5400, more preferably 2H or more, and most preferably 3H or more.

### (C-2) High-Refractive-Index Layer and Intermediate-Refractive-Index Layer

The layer of the antireflection film having a high refractive index consists of a curable film that contains: at least ultra-fine particles of high-refractive-index inorganic compound having an average particle size of 100 nm or less; and a matrix binder.

Fine particles of high-refractive-index inorganic compound include: for example, those of inorganic compounds having a refractive index of 1.65 or more and preferably 1.9 or more. Specific examples of such inorganic compounds include: oxides of Ti, Zn, Sb, Sn, Zr, Ce, Ta, La or In; and composite oxides containing these metal atoms.

Methods for forming such ultra-fine particles include: for example, treating the particle surface with a surface treatment agent (e.g. a silane coupling agent, Japanese Patent Application Laid-Open Nos. 11-295503, 11-153703, 2000-9908, an anionic compound or organic metal coupling agent, Japanese Patent Application Laid-Open No. 2001-310432 etc.); allowing particles to have a core-shell structure in which a core is made up of high-refractive-index particle(s) (Japanese Patent Application Laid-Open No. 2001-166104 etc.); and using a specific dispersant together (Japanese Patent Application Laid-Open No. 11-153703, U.S. Pat. No. 6,210,858B1, Japanese Patent Application Laid-Open No. 2002-2776069, etc.).

Materials used for forming a matrix include: for example, conventionally known thermoplastic resins and curable resin films.

Further, as such a material, at least one composition is preferable which is selected from the group consisting of: a composition including a polyfunctional compound that has at least two radically polymerizable and/or cationically polymerizable group; an organic metal compound containing a hydrolytic group; and a composition as a partially condensed product of the above organic metal compound. Examples of such materials include: compounds described in Japanese Patent Application Laid-Open Nos. 2000-47004, 2001-315242, 2001-31871 and 2001-296401.

A curable film prepared using a colloidal metal oxide obtained from the hydrolyzed condensate of metal alkoxide and a metal alkoxide composition is also preferred. Examples are described in Japanese Patent Application Laid-Open No. 2001-293818.

The refractive index of the high-refractive-index layer is generally 1.70 to 2.20. The thickness of the high-refractive-index layer is preferably 5 nm to 10 μm and more preferably 10 nm to 1 μm.

The refractive index of the intermediate-refractive-index layer is adjusted to a value between the refractive index of the low-refractive-index layer and that of the high-refractive-index layer. The refractive index of the intermediate-refractive-index layer is preferably 1.50 to 1.70.

### (C-3) Low-Refractive-Index Layer

The low-refractive-index layer is formed on the high-refractive-index layer sequentially in the laminated manner. The refractive index of the low-refractive-index layer is 1.20 to 1.55 and preferably 1.30 to 1.50.

Preferably, the low-refractive-index layer is formed as the outermost layer having scratch resistance and stainproofing properties. As significantly improving scratch resistance, it is effective to provide the surface of the layer with slip properties, and conventionally known thin film forming that includes introducing silicone or fluorine is used.

The refractive index of the fluorine-containing compound is preferably 1.35 to 1.50 and more preferably 1.36 to 1.47. The fluorine-containing compound is preferably a compound that includes a crosslinkable or polymerizable functional group containing fluorine atom in an amount of 35 to 80% by mass.

Examples of such compounds include: compounds described in Japanese Patent Application Laid-Open No. 9-222503, paragraphs [0018] to [0026], Japanese Patent Application Laid-Open No. 11-38202, paragraphs [0019] to [0030], Japanese Patent Application Laid-Open No. 2001-40284, paragraphs [0027] to [0028], Japanese Patent Application Laid-Open No. 2000-284102, etc.

A silicone compound is preferably such that it has a polysiloxane structure, it includes a curable or polymerizable functional group in its polymer chain, and it has a crosslinking structure in the film. Examples of such silicone compounds include: reactive silicone (e.g. SILAPLANE manufactured by Chisso Corporation); and polysiloxane having a silanol group on each of its ends (one described in Japanese Patent Application Laid-Open No. 11-258403).

The crosslinking or polymerization reaction for preparing such fluorine-containing polymer and/or siloxane polymer containing a crosslinkable or polymerizable group is preferably carried out by radiation of light or by heating simultaneously with or after applying a coating composition for forming an outermost layer, which contains a polymerization initiator, a sensitizer, etc.

A sol-gel cured film is also preferable which is obtained by curing the above coating composition by the condensation reaction carried out between an organic metal compound, such as silane coupling agent, and silane coupling agent containing a specific fluorine-containing hydrocarbon group in the presence of a catalyst.

Examples of such films include: those of polyfluoroalkyl-group-containing silane compounds or the partially hydrolyzed and condensed compounds thereof (compounds described in Japanese Patent Application Laid-Open Nos. 58-142958, 58-147483, 58-147484, 9-157582 and 11-106704); and silyl compounds that contain a poly “perfluoroalkyl ether” group as a fluoline-containing long-chain group (compounds described in Japanese Patent Application Laid-Open Nos. 2000-117902, 2001-48590 and 2002-53804).

The low-refractive-index layer can contain additives other than the above described ones, such as filler (e.g. low-refractive-index inorganic compounds whose primary particles have an average particle size of 1 to 150 nm, such as silicon dioxide (silica) and fluorine-containing particles (magnesium fluoride, calcium fluoride, barium fluoride); organic fine particles described in Japanese Patent Application Laid-Open No. 11-3820, paragraphs [0020] to [0038]), silane coupling agent, slippering agent and surfactant.

When located under the outermost layer, the low-refractive-index layer may be formed by vapor phase method (vacuum evaporation, spattering, ion plating, plasma CVD, etc.). From the viewpoint of reducing manufacturing costs, coating method is preferable.

The thickness of the low-refractive-index layer is preferably 30 to 200 nm, more preferably 50 to 150 nm, and most preferably 60 to 120 nm.

### (C-4) Hard Coat Layer

A hard coat layer is provided on the surface of the transparent substrate so as to impart physical strength to the antireflection film. It is particularly preferable to provide the hard coat layer between the transparent substrate and the above described high-refractive-index layer.

Preferably, the hard coat layer is formed by the crosslinking reaction or polymerization of compounds curable by light and/or heat. Preferred curable functional groups are photopolymerizable functional groups, and organic metal compounds having a hydrolytic functional group are preferably organic alkoxy silyl compounds.

Specific examples of such compounds include the same compounds as illustrated in the description of the high-refractive-index layer.

Specific examples of compositions that constitute the hard coat layer include: those described in Japanese Patent Application Laid-Open Nos. 2002-144913, 2000-9908 and WO 0/46617.

The high-refractive-index layer can also serve as a hard coat layer. In this case, it is preferable to form the hard coat layer using the technique described in the description of the high-refractive-index layer so that fine particles are contained in the hard coat layer in the finely dispersed manner.

The hard coat layer can also serves as an anti-glare layer (described later), if particles having an average particle size of 0.2 to 10 μm are added to provide the layer with the anti-glare function.

The thickness of the hard coat layer can be properly designed depending on the applications for which it is used. The hard coat layer preferably has a thickness of 0.2 to 10 μm and more preferably 0.5 to 7 μm.

The strength of the hard coat layer is preferably H or more, by pencil hardness test in accordance with JIS K5400, more preferably 2H or more, and much more preferably 3H or more. The hard coat layer having a smaller abrasion loss in test specimen, before and after Taber abrasion test conducted in accordance with JIS K5400, is more preferable.

### (C-5) Forward Scattering Layer

A forward scattering layer is provided so that it provides, when applied to liquid crystal display devices, the effect of improving viewing angle when the angle of vision is tilted up-, down-, right- or leftward. The above described hard coat layer can also serve as a forward scattering layer, if fine particles with different refractive indices are dispersed in it.

Examples of such layers include: those described in Japanese Patent Application Laid-Open No. 11-38208 where the coefficient of forward scattering is specified; those described in Japanese Patent Application Laid-Open No. 2000-199809 where the relative refractive index of transparent resin and fine particles are allowed to fall in the specified range; and those described in Japanese Patent Application Laid-Open No. 2002-107512 wherein the haze value is specified to 40% or more.

### (C-6) Other Layers

Besides the above described layers, a primer layer, an anti-static layer, an undercoat layer or a protective layer may be provided.

### (C-7) Coating Method

The layers of the antireflection film can be formed by any method of dip coating, air knife coating, curtain coating, roller coating, wire bar coating, gravure coating, microgravure coating and extrusion coating (U.S. Pat. No. 2,681,294).

### (C-8) Anti-Glare Function

The antireflection film may have the anti-glare function that scatters external light. The anti-glare function can be obtained by forming irregularities on the surface of the antireflection film. When the antireflection film has the anti-glare function, the haze of the antireflection film is preferably 3 to 30%, more preferably 5 to 20%, and most preferably 7 to 20%.

As a method for forming irregularities on the surface of antireflection film, any method can be employed, as long as it can sufficiently maintain the surface geometry of the film. Such methods include: for example, a method in which fine particles are used in the low-refractive-index layer to form irregularities on the surface of the film (e.g. Japanese Patent Application Laid-Open No. 2000-271878); a method in which a small amount (0.1 to 50% by mass) of particles having a relatively large size (0.05 to 2 μm in particle size) is added to the layer under a low-refractive-index layer (high-refractive-index layer, intermediate-refractive-index layer or hard coat layer) to form a film having irregularities on the surface and a low-refractive-index layer is formed on the irregular surface while keeping the geometry (e.g. Japanese Patent Application Laid-Open Nos. 2000-281410, 2000-95893, 2001-100004, 2001-281407); a method in which irregularities are physically transferred on the surface of the outermost layer (stainproofing layer) having been provided (e.g. embossing described in Japanese Patent Application Laid-Open Nos. 63-278839, 11-183710, 2000-275401).

Hereinafter, the measurement methods used in the present invention will be described.

### (1) Dimensional Change Under Wet Heating (δL(w))

(i) A sample film is cut in the directions of MD and TD and conditioned in an atmosphere of 25° C. and 60% rh for 5 hours or more, and then measured for the length by use of a pin gauge of a 20 cm base length (wherein the measured values are referred to as MD(F) and TD(F), respectively).

(ii) The cut and conditioned sample film is left standing with no tension in a thermo-humidistat oven at 60° C. and 90% rh for 500 hours (this treatment is referred to as “thermo-treatment”).

(iii) The sample is removed from the thermo-humidistat oven, conditioned in an atmosphere of 25° C. and 60% rh for 5 hours or more, and then measured for the length by use of a pin gauge of a 20 cm base length (wherein the measured values are referred to as MD(t) and TD (t), respectively).

(iv) The dimensional changes under wet heating (δMD(w) and δTD(w)) in the MD and the TD directions, respectively, are obtained according to the following formulas. Of these values, a larger one is referred to as the dimensional change under wet heating (δL(w)).

δTD(w)(%)=100×|TD(F)−TD(t)|/TD(F)

δMD(w)(%)=100×|MD(F)−MD(t)|/MD(F)

### (2) Dimensional Change Under Dry Heating (δL(d))

The dimensional change under dry heating (δL(d)) is determined in the same manner as described in the above dimensional change under wet heating (δL(w)) except that the “thermo-treatment” is conducted in a dry atmosphere at 80° C. for 500 hours.

### (3) Re and Rth

A sample film is humidity conditioned at 25° C. and 60% rh for 5 hours or more, and then measured at 25° C. and 60% rh for retardation values by use of an automatic birefringence analyzer (KOBRA-21ADH: manufactured by Oji Scientific Instruments) at a wavelength of 550 nm incident upon the surface of the sample film in the vertical direction and in the inclined direction at angle of ±40° from the normal line of a film plane. An in-plane retardation (Re) is calculated from the value measured in the vertical direction and a retardation in thickness direction (Rth) is calculated from the values measured in the vertical direction and the ±40° inclined direction. These calculated values are referred to as Re and Rth.

### (4) Change of Re and Rth Under Wet Heating

(i) A sample film is humidity conditioned at 25° C. and 60% rh for 5 hours or more, and then measured for Re and Rth by the method as described above (wherein the measured values are referred to as Re(f) and Rth(f), respectively).

(ii) The sample film is left standing with no tension in a thermo-humidistat oven at 60° C. and 90% rh for 500 hours (thermo treatment).

(iii) The sample film is removed from the thermo-humidistat oven, humidity conditioned in an atmosphere of 25° C. and 60% rh for 5 hours or more, and then measured for the Re and Rth in the manner as described above (wherein the measured values are referred to as Re(t) and Rth(t), respectively).

(iv) Changes of Re and Rth under wet heating are obtained by the following formulas.

Change of Re under wet heating(%)=100×(Re(f)−Re(t))/Re(f)

Change of Rth under wet heating(%)=100×(Rth(f)−Rth(t))/Rth(f)

### (5) Changes of Re and Rth Under Dry Heating

The changes of Re and Rth under dry heating are obtained in the same manner as described in the above changes of Re and Rth under wet heating except that the thermo-treatment is conducted in a dry atmosphere at 80° C. for 500 hours.

### (6) Fine Retardation Unevenness

A sample film is humidity conditioned in an atmosphere of 25° C. and 60% rh for 5 hours or more, and then is measured for Re at 10 points while being shifted by 0.1 mm in the MD direction by use of an ellipsometer (ABR-10A-10AT, automatic birefringence measurement apparatus manufactured by UNIOPT Corporation, Ltd.). A value (fine retardation unevenness in the MD direction) is obtained by dividing a difference between the maximum value and the minimum value by the average value of the measured values at the 10 points.

Fine retardation unevenness in the TD direction is also obtained by measuring the sample film while the sample film is shifted it by 0.1 mm in the TD direction.

Of the fine retardation unevenness values in the MD direction and in the TD direction, a larger one is defined as the fine retardation unevenness.

### (7) Length-to-Width Ratio

The length-to-width ratio is defined as a value (L/W) obtained by dividing an interval between nip rolls used for stretching (L: the distance between the cores of two pairs of nip rolls) by the width of a saturated norbornene resin film before stretching (W). When there are three pairs of nip rolls or more, a largest L/W value is defined as the length-to-width ratio.

### (8) Relaxation Rate

The relaxation rate is defined as a value obtained by: dividing the relaxation length by the dimension of a film before stretching; and expressing the resultant value in percentage.

In the following the features of the present invention will be described in further detail by referring to Examples and a Comparative Example. The materials, amounts thereof, ratios thereof and the contents and procedures of treatments shown in the following Examples may be properly modified without departing from the spirit of the present invention. Therefore, it should not be construed that the scope of the present invention is limited to the following specific Examples.

### EXAMPLES

The present invention will be more specifically explained by way of Examples: Experiments 1 to 5 (Examples) and Experiment 6 (Comparative Example). Experiment will be specifically described for Experiment 1 and experimental conditions different from those in Experiment 1 are summarized for Experiments 2 to 6 in Table 1. The materials, amounts thereof, ratios thereof and the contents and procedures of treatments shown in the following Examples may be properly modified without departing from the spirit of the present invention. Therefore, it should not be construed that the scope of the present invention is limited to the following specific Examples.

### [Experiment 1]

### (1) Manufacturing Saturated Norbornene Resin Aggregate

As a saturated norbornene resin, APL6013T (manufactured by Mitsui Chemicals, Inc.) was used, which will be hereinafter referred to as APL. The glass transition temperature Tg of the APL was 125° C. In manufacturing APL pellets, the following additives were added to APL.

| | | |
|---|---|---|
| APL | 100 | parts by weight |
| Stabilizer: Sumilizer GP | 0.3 | parts by weight |
| (Sumitomo Chemical Co., Ltd.) | | |

The stabilizer was dried at 80° C. for 3 hours so as to have a water content of 0.5 wt % or less.

| | | |
|---|---|---|
| Matting agent: Silicon dioxide particles | 0.05 | parts by weight |
| (Aerosil R972V) | | |
| UV absorbent: 2-(2′-hydroxy-3′,5-di-t- | 0.5 | parts by weight |
| butylphenyl)-benzotriazole | | |
| UV absorbent: 2,4-hydroxy-4-methoxy-benzo- | 0.6 | parts by weight |
| phenone | | |

The compound (pellet raw-material) 20 was charged in the hopper 11 of the manufacturing line 10′ shown in FIG. 3 and supplied from the hopper 11 to the extruder 12 (TEM-46, manufactured by Toshiba Machine Co., Ltd.). Extrusion from the extruder 12 was performed under the conditions: inner temperature: 220° C., a screw rotation number: 300 rpm, kneading time: 40 seconds, extrusion amount: 200 kg/hr. The resin was extruded from a die in the form of strand. The strand 21 was then fed to a cutting unit 14. The cutting unit 14 had a cutter 30 arranged so that the cutter had a cutting angle θ(°) of 45° C. (see FIG. 2). A super-hard alloy was selected as the material for the blade of the cutter 30. Furthermore, a water supply unit 31, which supplies water (hereinafter referred to as “washing water”) for removing powder generated when a strand was cut, was attached to the cutting unit 14 via a powder separation unit 32. The strand was cut by the cutter into cylindrical pellet precursors having a diameter of about 3 mm and a length of about 3 mm. The washing water with a temperature of about 65° C. was supplied at a flow rate of 100 m³/minute. This strand cutting method is represented as “water” in Table 1 described below.

Then, the pellet precursors were separated from water by a pellet/water separation unit 35 and continuously sent to a sieving unit 16 equipped with a sieve 18 having a mesh size of 1.3 mm. The pellet precursors were sieved through the sieve 18 to remove powder, which had not been removed yet by the previous washing water, thereby providing pellets 23. The pellets 23 were fed to a container 17 to have a pellet aggregate 24 obtained in the container 17. The sizes of particles of a pellet aggregate 24 were measured by a sieving method. As a result, the ratio of particles having an average diameter of 1 mm or less was 0.01 wt %. A pellet aggregate 24 having substantially uniform pellet precursors in size was obtained. The glass transition temperature Tg of the pellet aggregate was 120° C.

### (2) Melt Film Formation

The pellet aggregate 24 was dried by dehumidification air (having a dew point of −40° C.) at 100° C. for 5 hours to reduce a water content to 0.01 wt % or less. A film was manufactured by a film-manufacturing line 70 shown in FIG. 5 using the pellet aggregate 24 and the quality of the obtained film was evaluated.

The pellet aggregate was placed in a hopper 71 with a temperature of 80° C. and supplied to an extruder 72. As the extruder 72, a uniaxial screw extruder (manufactured by GM Engineering, a screw diameter of φ50 mm) 72 was used. The extruder 72 was cooled by circulating an oil with a temperature of (Tg of pellet aggregate 24)−5° C. (about 115° C.). The pellet aggregate 24 was controlled so as to stay in a barrel for 5 minutes. The temperatures of the outlet and inlet of the barrel were controlled to have the maximum temperature and the minimum temperature of the barrel, respectively. Then, the pellet aggregate was melted within the extruder 72. Hereinafter, the pellets thus melted will be referred to as “molten saturated norbornene resin”. The molten saturated norbornene resin extruded from the extruder 72 was measured by a gear pump 73, so that a fixed amount of molten saturated norbornene resin was fed out. The rotation number of the screw of the extruder 72 was controlled such that the pressure of the molten saturated norbornene resin immediately before reaching the gear pump 73 was controlled to be constant at 10 MPa. The molten saturated norbornene resin fed from the gear pump 73 was filtrated by a leaf-disk filter (not shown) having a filtration accuracy of 5 μm, passed through a static mixer, fed into a hanger coat die 75 having a slit interval of 0.8 mm and extruded from the hanger coat die 75 at 240° C. in the form of a sheet 90 (hereinafter referred to as “sheet-form saturated norbornene resin”). The temperature of the hanger coat die 75 was adjusted to 220° C.

The sheet-form saturated norbornene resin 90 was solidified by a casting drum 76 having a temperature of Tg-10° C. (about 110° C.). The sheet-form saturated norbornene resin 90 had a temperature of 230° C. when it was placed at a casting position. At this time, static electricity was applied to both ends (10 cm) of the sheet by an electrostatic application method (by setting a wire of 10 kV at a position having a distance of 10 cm apart from the casting position of the melt on the casting drum). The sheet-form saturated norbornene resin 90 was removed from the casting drum 76 and trimmed at both edges (each corresponding to 5% of the whole width of the film) immediately before rolling up. Thereafter, knurling was conducted so as to give a height of 50 μm in a 10-mm width to each of both edges of the sheet and the sheet was rolled up into a roll having 3000 m in length, at a rate of 5 m/minute. The film thus obtained (hereinafter referred to as an unstretched saturated norbornene resin film) had a width of 1.5 m and an average thickness of 100 μm.

### (3) Evaluation of Unstretched Saturated Norbornene Resin Film

### (i) Determination of Film Quality

The film-quality of an unstretched saturated norbornene resin film was evaluated by an optical microscope based on 4 step evaluations (A to C: acceptable level, D: unacceptable level). The saturated norbornene resin film obtained in the conditions of Experiment 1 was evaluated as A.

A: No foreign matters are observed on the film surface

B: Foreign matters are rarely observed on the film surface

C: Foreign matters are slightly observed on the film surface but the film can be used in practice as a film product

D: Numerous foreign matters are observed on the film surface and thus the film cannot be used as a base film for a film product.

### [Experiment 2]

In Experiment 2 as an Example of the present invention, a pellet aggregate was manufactured in the same conditions as in Experiment 1 except that the cutting angle θ(°) of the cutter was set at 25°. The content of powder in the pellet aggregate was 0.03 wt %, which had no problem in practice. Furthermore, this obtained pellet aggregate was used to manufacture a film by conducting melt film formation in the same conditions as in Experiment 1. The quality of the manufactured film was evaluated as B.

### [Experiment 3]

In Experiment 3 as an Example of the present invention, a pellet aggregate was manufactured in the same conditions as in Experiment 1 except that the temperature of water was set at 20° C. The content of powder in the pellet aggregate was 0.05 wt %, which had no problem in practice. Furthermore, this obtained pellet aggregate was used to manufacture a film by conducting melt film formation in the same conditions as in Experiment 1. The quality of the manufactured film was evaluated as B.

### [Experiment 4]

In Experiment 4 as an Example of the present invention, a pellet aggregate 47 was manufactured in the same conditions as in Experiment 1 except that a sieving unit was not provided. The content of powder in the pellet aggregate 47 was 0.07 wt %, which had no problem in practice. Furthermore, this obtained pellet aggregate 47 was used to manufacture a film by conducting melt film formation in the same conditions as in Experiment 1. The quality of the manufactured film was evaluated as C.

### [Experiment 5]

In Experiment 5 as an Example of the present invention, a pellet aggregate 57 was manufactured in the same conditions as in Experiment 1 except that water was not supplied at the time of cutting a strand. This strand cutting method is represented by S in Table 1. The content of powder in the pellet aggregate 57 was 0.08 wt %, which had no problem in practice. Furthermore, this obtained pellet aggregate 57 was used to manufacture a film by conducting melt film formation in the same conditions as in Experiment 1. The quality of the manufactured film was evaluated as C.

### [Experiment 6]

In Experiment 6 as a Comparative Example, a pellet aggregate was manufactured by a method wherein no water was supplied (the strand cutting method S) and no sieving unit was used at the time of cutting a strand. The content of powder in the pellet aggregate was 0.80 wt %, which exceeded the acceptable range of powder content (0.1 wt % or less). Furthermore, this obtained pellet aggregate was used to manufacture a film by melt film formation in the same conditions as in Experiment 1. The quality of the manufactured film was evaluated as D, and thus the film could not be used as a base film of a film product.

TABLE 1

| | | Cut- | | | | |
|---|---|---|---|---|---|---|
| | Strand | ting | | Water | Powder | |
| | cutting | angle | | temperature | content | Film |
| | method | (°) | Sieving unit | (° C.) | wt % | quality |
| Experi- | Water | 45 | Equipped | 60 | 0.01 | A |
| ment 1 | | | | | | |
| Experi- | Water | 25 | Equipped | 60 | 0.03 | B |
| ment 2 | | | | | | |
| Experi- | Water | 45 | Equipped | 20 | 0.05 | B |
| ment 3 | | | | | | |
| Experi- | Water | 45 | Unequipped | 60 | 0.07 | C |
| ment 4 | | | | | | |
| Experi- | S | 45 | Equipped | 60 | 0.08 | C |
| ment 5 | | | | | | |
| Experi- | S | 45 | Unequipped | 60 | 0.8 | D |
| ment 6 | | | | | | |

What is claimed is:

1. A method for manufacturing a pellet aggregate by melting a raw material including a saturated norbornene resin and an additive to prepare a fluid, and cutting the fluid into pellets, the method comprising
performing the cutting of the fluid into the pellets in a liquid to separate powder generated in manufacturing the pellets together with the liquid, whereby
the content of the powder in the pellet aggregate becomes a predetermined amount or less.

2. The method for manufacturing a pellet aggregate according to claim 1, further comprising
passing the manufactured pellets through a sieve having a mesh size of 1 mm or more and 2 mm or less to separate the powder in the pellet aggregate.

3. The method for manufacturing a pellet aggregate according to claim 1, wherein
the liquid is water.

4. The method for manufacturing a pellet aggregate according to claim 3, wherein
the water has a temperature of 35° C. or more and 90° C. or less.

5. A method for manufacturing a pellet aggregate by melting a raw material including a saturated norbornene resin and an additive to prepare a fluid, and cutting the fluid into pellets, the method comprising
passing the manufactured pellets through a sieve having a mesh size of 1 mm or more and 2 mm or less to separate powder generated in manufacturing the pellets, whereby
the content of the powder in pellet aggregate becomes a predetermined amount or less.

6. The method for manufacturing a pellet aggregate according to claim 1, wherein
the fluid is cut by a blade arranged so as to have a cutting angle θ(°) of 30° or more and 75° or less when a forward direction of the fluid is taken as 0°.

7. The method for manufacturing a pellet aggregate according to claim 1, wherein
the powder has an average particle size of 1 mm or less measured by a sieving method.

8. The method for manufacturing a pellet aggregate according to claim 1, wherein
the content of powder is 0.1% by mass or less.

9. The method for manufacturing a pellet aggregate according to claim 1, wherein
the additive comprises at least one plasticizer.

10. The method for manufacturing a pellet aggregate according to claim 1, wherein
the pellet aggregate is a raw material for a saturated norbornene resin film.

11. The method for manufacturing a pellet aggregate according to claim 5, wherein
the fluid is cut by a blade arranged so as to have a cutting angle θ(°) of 30° or more and 75° or less when a forward direction of the fluid is taken as 0°.

12. The method for manufacturing a pellet aggregate according to claim 5, wherein
the powder has an average particle size of 1 mm or less measured by a sieving method.

13. The method for manufacturing a pellet aggregate according to claim 5, wherein
the content of powder is 0.1% by mass or less.

14. The method for manufacturing a pellet aggregate according to claim 5, wherein
the additive comprises at least one plasticizer.

15. The method for manufacturing a pellet aggregate according to claim 5, wherein
the pellet aggregate is a raw material for a saturated norbornene resin film.
